(19) United States
(12) Patent Application Publication
(10) Pub. No.: US 2024/0235773 A1
(43) Pub. Date: Jul. 11, 2024

(54) TECHNIQUES FOR ENHANCED PHASE TRACKING REFERENCE SIGNAL OPERATION

(71) Applicant: Intel Corporation, Santa Clara, CA (US)

(72) Inventors: Guotong WANG, Santa Clara, CA (US); Alexei DAVYDOV, Santa Clara, CA (US)

(21) Appl. No.: 18/559,990

(22) PCT Filed: Oct. 31, 2022
(86) PCT No.: PCT/US2022/048453

§ 371 Date: Nov. 9, 2023

(30) Foreign Application Priority Data
Nov. 8, 2021 (WO) PCT/CN2021/129196
Dec. 9, 2021 (WO) PCT/CN2021/136687
Mar. 17, 2022 (WO) PCT/CN2022/081358

(51) Int. Cl. H04L 5/00; H04W 72/232

(52) U.S. Cl. CPC H04L 5/0051; H04W 72/232

(57) ABSTRACT

Systems, apparatuses, methods, and computer-readable media are provided for enhanced phase tracking reference signal (PTRS) operation. Additionally, embodiments are provided for partial sounding and/or frequency hopping for sounding reference signal (SRS) with repetition. Other embodiments may be described and claimed.

### CROSS REFERENCE TO RELATED APPLICATION

The present application claims priority to International Patent Application No. PCT/CN2021/129196, which was filed Nov. 8, 2021; International Patent Application No. PCT/CN2021/136687, which was filed Dec. 9, 2021; and to International Patent Application No. PCT/CN2022/081358, which was filed Mar. 17, 2022.

### FIELD

Various embodiments generally may relate to the field of wireless communications. For example, some embodiments may relate to enhanced phase tracking reference signal operation.

### BACKGROUND

In 3GPP New Radio (NR) Release (Rel)-15/Rel-16 specification, the phase tracking reference signal (PTRS) is supported for phase noise tracking. In uplink, up to two ports can be configured for PTRS.

For codebook based transmission, single port PTRS is used for full coherent user equipment (UE). For partial-coherent and non-coherent UE, if the maximum number of PTRS ports is configured as two, then the actual PTRS ports and the mapping between PTRS port and physical uplink shared channel (PUSCH) port is determined by the indicated transmission precoding matrix indicator (TPMI).

For non-codebook based transmission, the sounding reference signal (SRS) resource can be configured with radio resource control (RRC) parameter ptrs-PortIndex indicating the association between PTRS port and SRS resource.

### BRIEF DESCRIPTION OF THE FIGURES

FIG. 1 illustrates mapping between PTRS port and PUSCH port.

FIG. 2 illustrates example mapping between PTRS port and PUSCH port, in accordance with various embodiments.

FIG. 3 illustrates another example mapping between PTRS port and PUSCH port, in accordance with various embodiments.

FIG. 4 illustrates a radio resource control (RRC) configuration for a sounding reference signal (SRS) resource set.

FIG. 5A-5B illustrates an example of an RRC configuration for an SRS resource.

FIG. 6 illustrates an example of SRS frequency hopping for {N_{symbol}, R}={4,2} and {N_{symbol}, R}={4,1}, in accordance with various embodiments.

FIG. 7A-7B illustrates an example of SRS partial sounding and starting resource block (RB) hopping, in accordance with various embodiments.

FIG. 8A-8B illustrates an example of partial sounding without and with starting RB hopping in one frequency hopping period, in accordance with various embodiments.

FIG. 9 illustrates a network in accordance with various embodiments.

FIG. 10 schematically illustrates a wireless network in accordance with various embodiments.

FIG. 11 is a block diagram illustrating components, according to some example embodiments, able to read instructions from a machine-readable or computer-readable medium (e.g., a non-transitory machine-readable storage medium) and perform any one or more of the methodologies discussed herein.

FIGS. 12, 13, and 14 depict example procedures for practicing the various embodiments discussed herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

In NR Rel-15/Rel-16 spec, the phase tracking reference signal (PTRS) is supported for phase noise tracking. In uplink, up to two ports can be configured for PTRS.

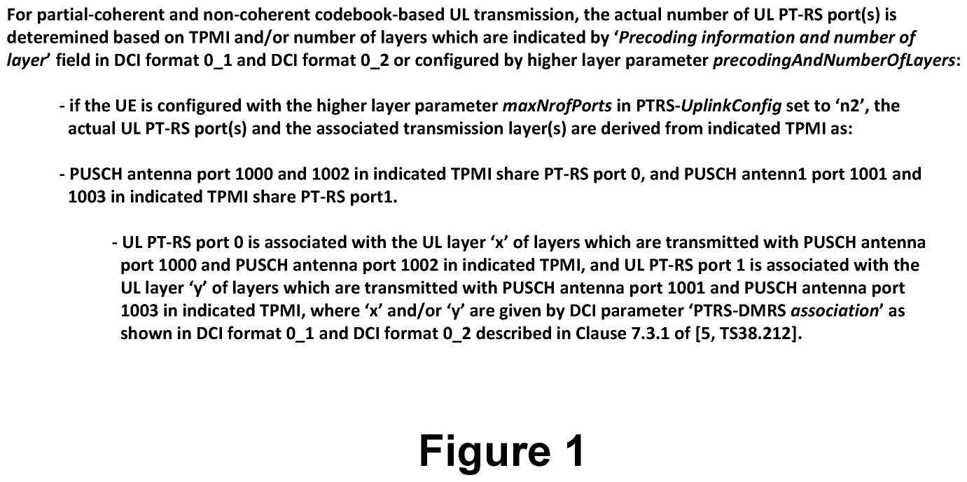

For codebook based transmission, single port PTRS is used for full coherent UE. For partial-coherent and non-coherent UE, if the maximum number of PTRS ports is configured as two, then the actual PTRS ports and the mapping between PTRS port and PUSCH port is determined by the indicated TPMI. FIG. 1 illustrates an example.

For non-codebook based transmission, the SRS resource can be configured with RRC parameter ptrs-PortIndex indicating the association between PTRS port and SRS resource.

In Rel-18, simultaneous transmission from multiple UE antenna panels (for example, two or four panels) will be supported, and up to 8 layers can be supported for uplink transmission. Therefore, the PTRS operation should be enhanced correspondingly.

There is no current solution to address this issue. The current PTRS operation only supports two port operation.

Various embodiments herein provide techniques for PTRS operation to support simultaneous transmission from multiple UE antenna panels and up to 8 layers transmission in uplink.

Various embodiments further provide techniques for SRS partial sounding for SRS with repetition.

### Enhanced PTRS Operation

In an embodiment, the number of PTRS ports may be extended for uplink if the UE supports simultaneous transmission from multiple UE antenna panels. If the number of simultaneous active panel for uplink transmission is N, then the number of PTRS ports should be extended to N. Each PTRS port is mapped to each UE antenna panel. This could be applied to all the uplink waveforms, such as CP-OFDM and DFT-s-OFDM. For example, if the number of simultaneous transmission panels is 4, then 4-port PTRS should be supported.

In an embodiment, for codebook based uplink transmission, multiple SRS resource sets may be configured, and each SRS resource set corresponds to one UE antenna panel. In the DCI scheduling PUSCH transmission, multiple SRI fields could be included, and each SRI corresponds to one UE antenna panel. Correspondingly, multiple TPMI fields could be included, and each TPMI field correspond to one UE antenna panel. In such case, each TPMI corresponds to one PTRS port.

In another embodiment, for codebook based uplink transmission, only one SRS resource set may be configured to the UE and only one TPMI field is signaled to the UE in the DCI. If the UE can support simultaneous transmission from multiple panels, and the number of PTRS ports is N, for example, N=4, then each PTRS port is associated with a subset of the PSUCH ports. For example, PUSCH port #0 and #2 is associated with PTRS port #0, PUSCH port #1 and #3 is associated with PTRS port #1, PUSCH port #4 and #6 is associated with PTRS port #2, and PUSCH port #5 and #7 is associated with PTRS port #3.

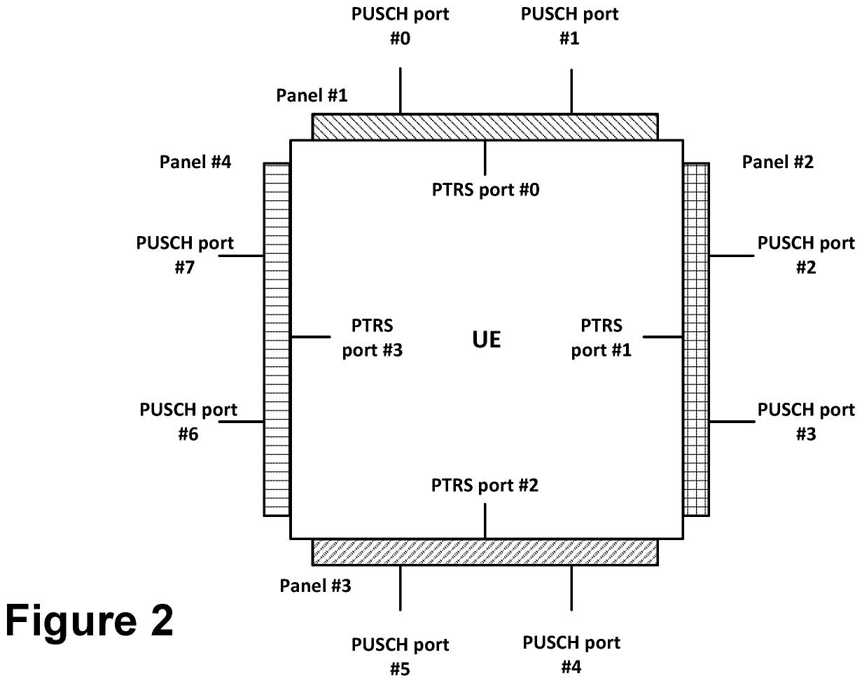

In another example, PUSCH port #0 and #1 is associated with PTRS port #0, PUSCH port #2 and #3 is associated with PTRS port #1, PUSCH port #4 and #5 is associated with PTRS port #2, PUSCH port #6 and #7 is associated with PTRS port #3. FIG. 2 shows the example of the mapping.

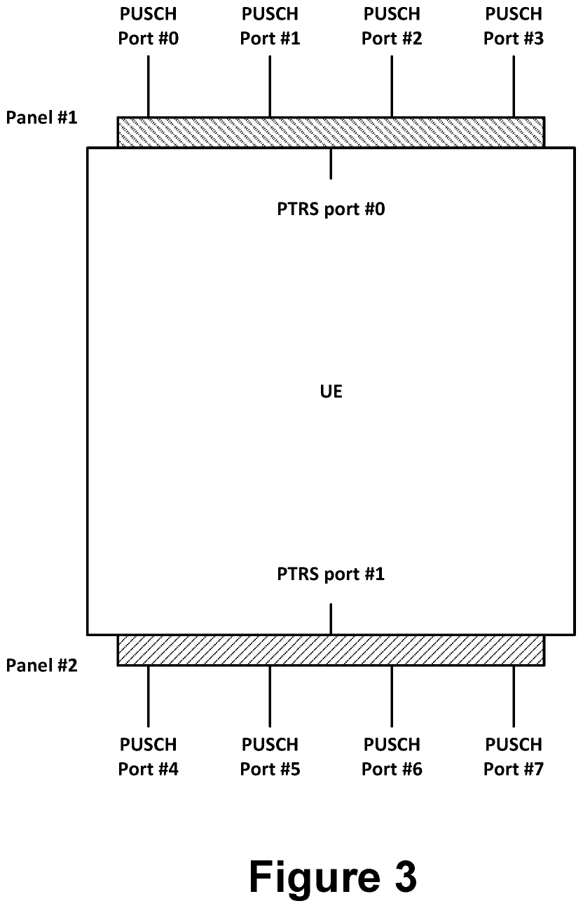

In another example, if the UE supports two panels, then the number of PTRS ports is two. Each PTRS port is associated with a subset of PUSCH ports. For example, PUSCH port #0, #2, #4, #6 are associated with PTRS port #0, and PUSCH port #1, #3, #5, #7 are associated with PTRS port #1. Or PUSCH port #0, #1, #2, #3 are associated with PTRS port #0, and PUSCH port #4, #5, #6, #7 are associated with PTRS port #1, as shown in FIG. 3.

In another embodiment, the PTRS-DMRS field may be extended. Or multiple PTRS-DMRS field may be included in the scheduling DCI.

In another embodiment, PTRS-DMRS field in DCI should be extended from two bits to three or four bits to support uplink transmission with up to 8 Tx and/or with multiple panels.

If the maximum number of PTRS ports is configured as one (for example, the UE has one panel with up to 8Tx), then the PTRS-DMRS field could be extended to three bits as shown in Table 1.

TABLE 1
PTRS-DMRS association (3 bits) for PTRS port 0
(maximum number of PTRS port is 1)

| Value | DMRS port |
|---|---|
| 0 | 1^{st} scheduled DMRS port |
| 1 | 2^{nd} scheduled DMRS port |
| 2 | 3^{rd} scheduled DMRS port |
| 3 | 4^{th} scheduled DMRS port |
| 4 | 5^{th} scheduled DMRS port |
| 5 | 6^{th} scheduled DMRS port |
| 6 | 7^{th} scheduled DMRS port |
| 7 | 8^{th} scheduled DMRS port |

If the maximum number of PTRS ports is configured as two (for example, the UE has two panels, and each panel has 4 Tx), then the PTRS-DMRS field could be extended to four bits as shown in Table 2.

TABLE 2
PTRS-DMRS association (4 bits) for PTRS port
0 and port 1 (maximum number of PTRS port is 2)

| Value of | | Value of | |
|---|---|---|---|
| the first | | the last | |
| two bits | DMRS port | two bits | DMRS port |
| 0 | 1^{st} DMRS port which | 0 | 1^{st} DMRS port which shares |
| | shares PTRS port 0 | | PTRS port 1 |
| 1 | 2^{nd} DMRS port which | 1 | 2^{nd} DMRS port which |
| | shares PTRS port 0 | | shares PTRS port 1 |
| 2 | 3^{rd} DMRS port which | 2 | 3^{rd} DMRS port which |
| | shares PTRS port 0 | | shares PTRS port 1 |
| 3 | 4^{th} DMRS port which | 3 | 4^{th} DMRS port which |
| | shares PTRS port 0 | | shares PTRS port 1 |

If the maximum number of PTRS ports is configured as four (for example, the UE has four panels, and each panel has 2 Tx), then the PTRS-DMRS field could be extended as shown in Table 3.

TABLE 3
PTRS-DMRS association (4 bits) for PTRS port 0
to port 3 (maximum number of PTRS port is 4)

| Value | | Value | | Value | | Value | |
|---|---|---|---|---|---|---|---|
| (1^{st} bit) | DMRS port | (2^{nd} bit) | DMRS port | (3^{rd} bit) | DMRS port | (4^{th} bit) | DMRS port |
| 0 | 1^{st} DMRS | 0 | 1^{st} DMRS | 0 | 1^{st} DMRS | 0 | 1^{st} DMRS |
| | port which | | port which | | port which | | port which |
| | shares PTRS | | shares PTRS | | shares PTRS | | shares PTRS |
| | port 0 | | port 1 | | port 2 | | port 3 |
| 1 | 2^{nd} DMRS | 1 | 2^{nd} DMRS | 1 | 2^{nd} DMRS | 1 | 2^{nd} DMRS |
| | port which | | port which | | port which | | port which |
| | shares PTRS | | shares PTRS | | shares PTRS | | shares PTRS |
| | port 0 | | port 1 | | port 2 | | port 3 |

Note: this embodiment could be applied to both codebook based transmission and non-codebook based transmission.

In another embodiment, when multiple SRS resource sets are configured for codebook/non-codebook based transmission, then in DCI multiple PTRS-DMRS association fields could be configured and/or the PTRS-DMRS association field could be extended.

If the maximum number of PTRS ports is configured as one (for example, the UE has one panel with up to 8Tx) and two SRS resource sets are configured, then one PTRS-DMRS field could be configured and it is extended to three bits as shown in Table 1. Or two PTRS-DMRS fields could be configured, and each field is three bits as shown in Table 1 (in such case, each field is for PTRS port 0, and each field is for DMRS port 0˜7. And each field corresponds to different SRI/TPMI field. For example, this could correspond to TDMed transmission from multi-panels).

Or two PTRS-DMRS fields could be configured, and each field is 2 bits, as shown in Table 4 (in such case, each field is for PTRS port 0. And each field corresponds to different SRI/TPMI field).

TABLE 4
PTRS-DMRS association for PTRS port 0
(maximum number of PTRS port is 1)

| 1^{st} PTRS-DMRS field | | 2^{nd} PTRS-DMRS field | |
|---|---|---|---|
| Value | DMRS port | Value | DMRS port |
| 0 | 1^{st} scheduled DMRS | 0 | 5^{th} scheduled DMRS |
| | port | | port |
| 1 | 2^{nd} scheduled DMRS | 1 | 6^{th} scheduled DMRS |
| | port | | port |
| 2 | 3^{rd} scheduled DMRS | 2 | 7^{th} scheduled DMRS |
| | port | | port |
| 3 | 4^{th} scheduled DMRS | 3 | 8^{th} scheduled DMRS |
| | port | | port |

If the maximum number of PTRS ports is configured as two (for example, the UE has two panels, and each panel has 4 Tx) and two SRS resource sets are configured, then one PTRS-DMRS field could be configured and it is extended to four bits as shown in Table 2. Or two PTRS-DMRS fields could be configured, and each field is four bits as shown in Table 2 (in such case, each field is for PTRS port 0 and port 1. And each field corresponds to different SRI/TPMI field. For example, this could correspond to TDMed transmission from multi-panels).

Or two PTRS-DMRS fields could be configured, and each field is 2 bits, as shown in Table 5 (in such case, the 1st field is for PTRS port 0, and the 2nd field is for PTRS port 1. And each field corresponds to different SRI/TPMI field).

TABLE 5
PTRS-DMRS association for PTRS port
0 and port 1 (maximum number of PTRS port is 2)

| 1^{st} PTRS-DMRS field | | 2^{nd} PTRS-DMRS field | |
|---|---|---|---|
| Value | DMRS port | Value | DMRS port |
| 0 | 1^{st} DMRS port which | 0 | 1^{st} DMRS port which |
| | shares PTRS port 0 | | shares PTRS port 1 |
| 1 | 2^{nd} DMRS port which | 1 | 2^{nd} DMRS port which |
| | shares PTRS port 0 | | shares PTRS port 1 |
| 2 | 3^{rd} DMRS port which | 2 | 3^{rd} DMRS port which |
| | shares PTRS port 0 | | shares PTRS port 1 |
| 3 | 4^{th} DMRS port which | 3 | 4^{th} DMRS port which |
| | shares PTRS port 0 | | shares PTRS port 1 |

If the maximum number of PTRS ports is configured as four (for example, the UE has four panels, and each panel has 2 Tx) and four SRS resource sets are configured, then one PTRS-DMRS field could be configured and it is extended to four bits as shown in Table 3. Or four PTRS-DMRS fields could be configured, and each field is four bits as shown in Table 3 (in such case, each field is for PTRS port 0 to port 3. And each field corresponds to different SRI/TPMI field. For example, this could correspond to TDMed transmission from multi-panels).

Or two PTRS-DMRS fields could be configured, and each field is 1 bits, as shown in Table 6 (in such case, the 1^{st} field is for PTRS port 0, the 2^{nd} field is for PTRS port 1, the 3^{rd} field is for PTRS port 2, and the 4^{th} field is for PTRS port 3. And each field corresponds to different SRI/TPMI field).

TABLE 6
PTRS-DMRS association for PTRS port 0 to
port 3 (maximum number of PTRS port is 4)

| 1^{st} PTRS-DMRS field | | 2^{nd} PTRS-DMRS field | | 3^{rd} PTRS-DMRS field | | 4^{th} PTRS-DMRS field | |
|---|---|---|---|---|---|---|---|
| Value | DMRS port | Value | DMRS port | Value | DMRS port | Value | DMRS port |
| 0 | 1^{st} DMRS | 0 | 1^{st} DMRS | 0 | 1^{st} DMRS | 0 | 1^{st} DMRS |
| | port which | | port which | | port which | | port which |
| | shares PTRS | | shares PTRS | | shares PTRS | | shares PTRS |
| | port 0 | | port 1 | | port 2 | | port 3 |
| 1 | 2^{nd} DMRS | 1 | 2^{nd} DMRS | 1 | 2^{nd} DMRS | 1 | 2^{nd} DMRS |
| | port which | | port which | | port which | | port which |
| | shares PTRS | | shares PTRS | | shares PTRS | | shares PTRS |
| | port 0 | | port 1 | | port 2 | | port 3 |

In another embodiment, when generating PTRS sequence and mapping PTRS to frequency resource, the parameter k_{ref}^{RE} indicating the reference RE position should also be extended in order to support UL transmission with up to 8Tx. An example of the k_{ref}^{RE} extension is shown in Table 7.

TABLE 7
Parameter k_{ref}^{RE}

| DMRS | | | | |
|---|---|---|---|---|
| antenna | DMRS Type-1 | | | |
| port | Offset00 | Offset01 | Offset10 | Offset11 |
| 0 | 0 | 2 | 6 | 8 |
| 1 | 2 | 4 | 8 | 10 |
| 2 | 1 | 3 | 7 | 9 |
| 3 | 3 | 5 | 9 | 11 |
| 4 | 4 | 6 | 10 | 0 |
| 5 | 6 | 8 | 0 | 2 |
| 6 | 5 | 7 | 11 | 1 |
| 7 | 7 | 9 | 1 | 3 |

In another embodiment, for non-codebook based uplink transmission, the RRC parameter ptrs-PortIndex may be extended to support more PTRS ports. For example, the value of ptrs-PortIndex may be extended to {1, 2, 3, 4} to support 4-port PTRS operation.

In another example, for non-codebook based uplink transmission, multiple SRS resource sets could be configured to the UE which can support simultaneous transmission from multiple panels. Each SRS resource set corresponds to one UE antenna panel. Each antenna panel is associated with one PTRS port. The SRS resources within one SRS resource set may be associated with the same PTRS port index.

Partial Sounding for SRS with Repetition

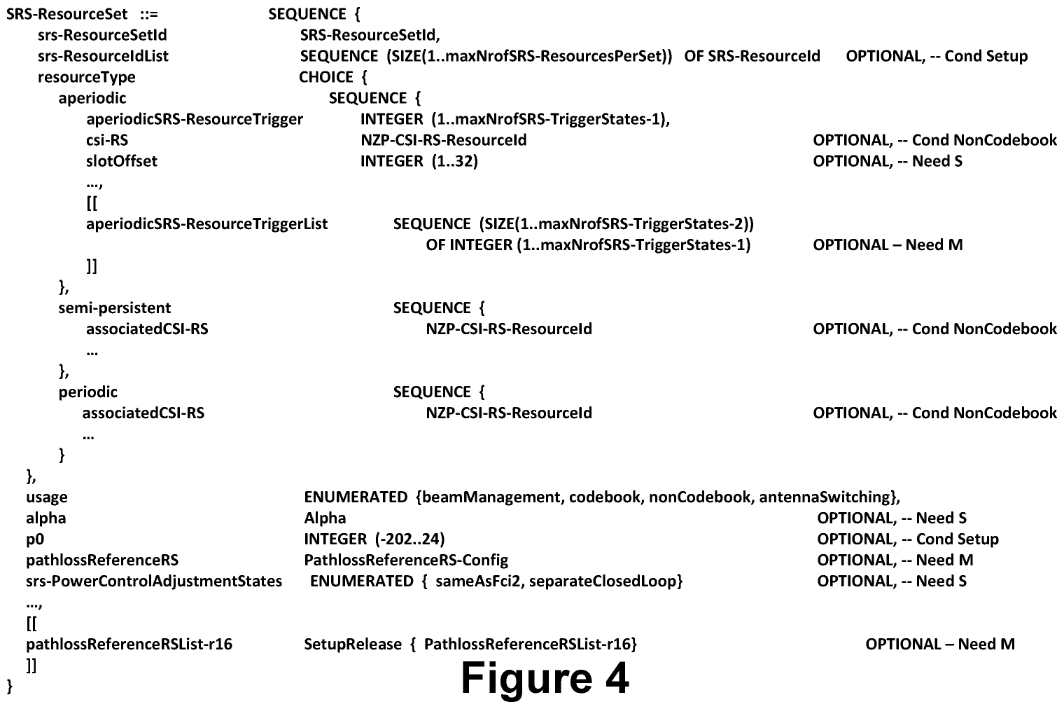

In NR Rel-15/Rel-16 spec, different types of SRS resource sets are supported. The SRS resource set is configured with a parameter of ‘usage’, which can be set to ‘beamManagement’, ‘codebook’, ‘nonCodebook’ or ‘antennaSwitching’. The SRS resource set configured for beamManagement is used for beam acquisition and uplink beam indication using SRS. The SRS resource set configured for ‘codebook’ and ‘nonCodebook’ is used to determine the UL precoding with explicit indication by TPMI (transmission precoding matrix index) or implicit indication by SRI (SRS resource index). Finally, the SRS resource set configured for ‘antennaSwitching’ is used to acquire DL channel state information (CSI) using SRS measurements in the UE by leveraging reciprocity of the channel in TDD systems. For SRS transmission, the time domain behavior could be periodic, semi-persistent or aperiodic. FIG. 4 shows the RRC configuration for SRS resource set. Multiple SRS resource sets could be configured to the UE. Each SRS resource set could be configured with one or multiple SRS resources.

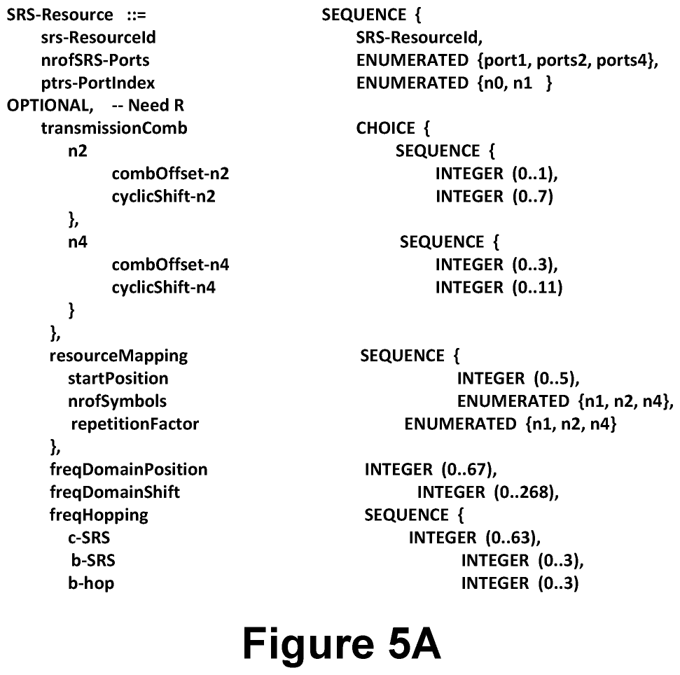

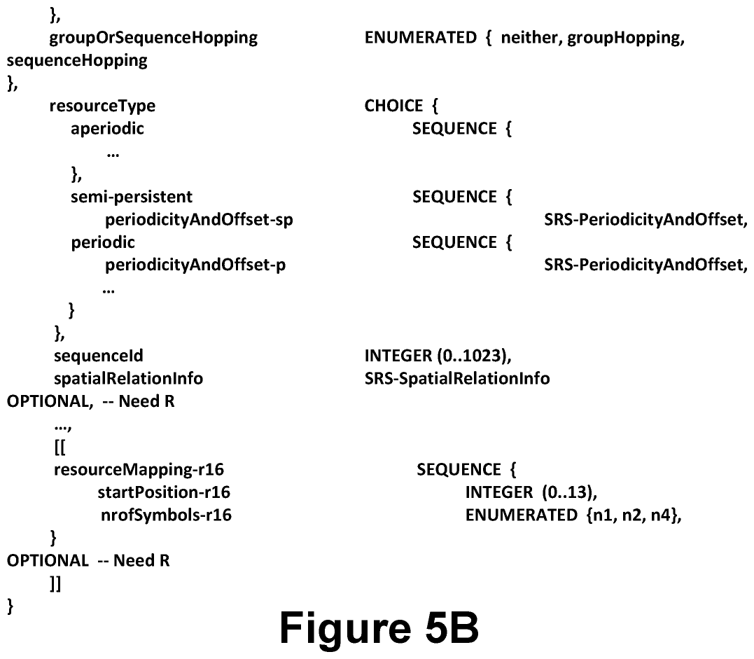

FIGS. 5A and 5B show an example of the RRC configuration for SRS resource in Rel-16.

For an SRS resource, it could be configured with N_{symbol} consecutive OFDM symbols, and N_{symbol} is given by RRC parameter nrofSymbols. In Rel-16, N_{symbol}∈{1, 2, 4}. The SRS resource could be configured with repetition factor, R∈{1, 2, 4}, and R≤N_{symbol}. The repetition factor is given by RRC parameter repetitionFactor.

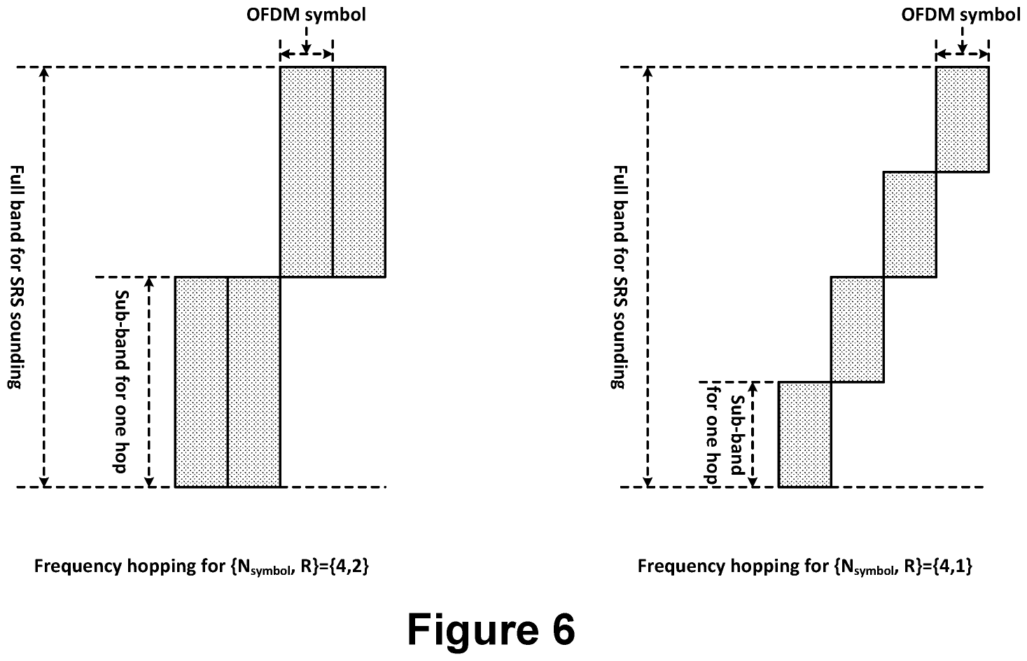

The SRS resource could be configured with frequency hopping. FIG. 6 shows examples of SRS frequency hopping for {N_{symbol}, R}={4,2} and {N_{symbol}, R}={4,1}.

In Rel-17, SRS partial sounding is introduced. With partial sounding, within the sub-band (given by m_{SRS,B}_{_{SRS}}) for one hop, the SRS could be transmitted only over a subset of PRBs within the sub-band. The UE could be configured with a partial sounding factor, P_{F}∈{2, 4}. The sub-band is equally divided into P_{F} parts

$$( the size of each part is \frac{1}{{P}_{F}} {m}_{SRS , {B}_{SRS}} ) .$$

The UE could be further configured with another parameter k_{F}∈{0, 1, . . . , P_{F}−1} to indicate the SRS will be transmitted over the (k_{F}+1)-th part of the sub-band. The starting RB position could be hopped over different frequency hopping period and the starting RB hopping is applied for periodic/semi-persistent SRS. The starting RB position is defined by

$${N}_{offset} = \frac{( {k}_{F} + {k}_{hopping} ) mod {P}_{F}}{{P}_{F}} {m}_{SRS , {B}_{SRS}} .$$

could be determined by pattern {0, 1} for P_{F}=2, and pattern {0, 2, 1, 3} for P_{F}=4. With pattern {x₀, . . . , X_{P}_{_{F}}₋₁}, k_{hopping}=X_{n mod P}_{_{F}} for the (n+1)-th frequency hopping period. The starting RB hopping is applied for different frequency hopping period. Within one frequency hopping period, there is no starting RB hopping.

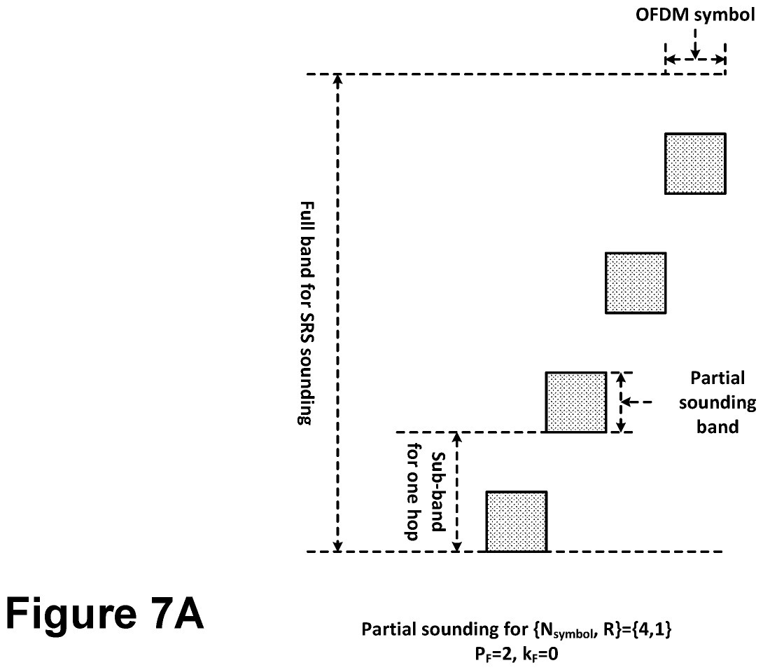

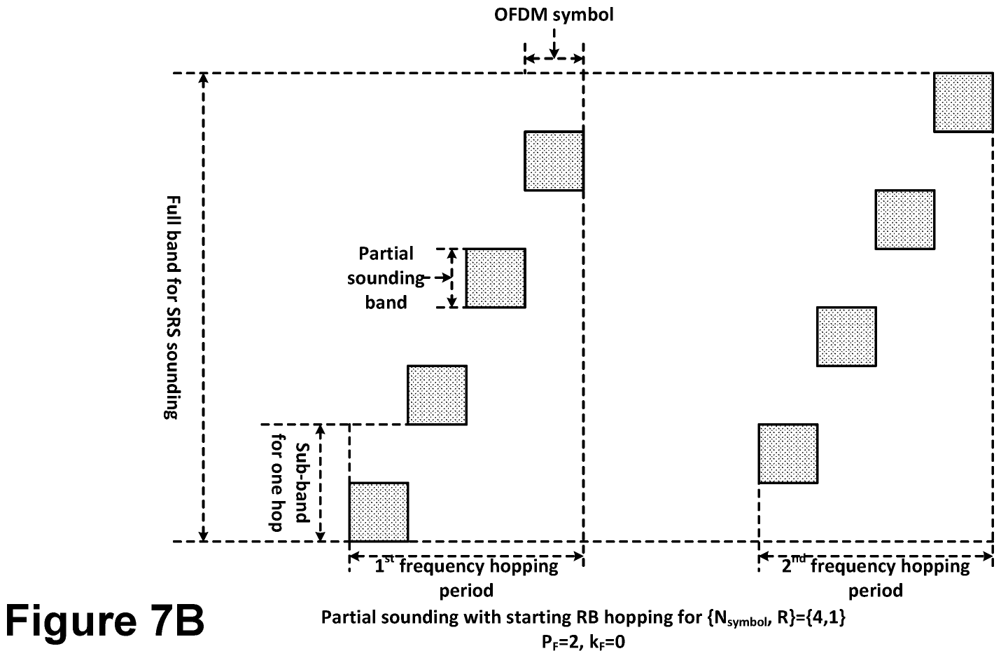

FIGS. 7A and 7B show an example of the SRS partial sounding and starting RB hopping.

In Rel-17, the repetition factor and number of symbols for SRS are extended. In addition to the legacy repetition factor and number of symbols, the following configurations are supported. {N_{symbol}, R}={(8,1), (8,2), (8,4), (8,8), (12,1), (12,2), (12,3), (12,4), (12,6), (12,12), (10,1), (10,2), (10,5), (10,10), (14,1), (14,2), (14,7), (14,14)}.

With the increased repetitions, it would be beneficial to apply starting RB hopping when partial sounding is applied, especially if the repetition factor is larger than 1.

The current SRS partial sounding doesn't apply starting RB hopping within one frequency hopping period.

Various embodiments herein include techniques to apply starting RB hopping within one frequency hopping period for periodic/semi-persistent SRS or to apply starting RB hopping for aperiodic SRS.

In an embodiment, for SRS with number of symbols N_{symbol}∈{1, 2, 4, 8, 10, 12, 14} and repetition factor of R, the frequency hopping could be applied. The number of hops N_{Hop} is given by N_{Hop}=N_{symbol}/R. Each hop includes R OFDM symbols. Over different symbols within each hop, the SRS is transmitted over the same set of sub-carriers. For different hop, the SRS is transmitted over different set of sub-carriers. For periodic SRS and semi-persistent SRS, inter-slot hopping and intra-slot hopping could be supported. For aperiodic SRS, intra-slot frequency hopping is supported.

For SRS with number of symbols N_{symbol}∈{1, 2, 4, 8, 10, 12, 14} and repetition factor of R, when partial sounding is applied, the starting RB hopping could be applied within one frequency hopping period for periodic/semi-persistent SRS. Or the starting RB hopping could be applied for aperiodic SRS.

In another embodiment, the partial sounding with starting RB hopping could be applied within one frequency hopping period for periodic/semi-persistent SRS when the repetition factor R is larger than one. Or the partial sounding with starting RB hopping could be for aperiodic SRS when the repetition factor R is larger than one.

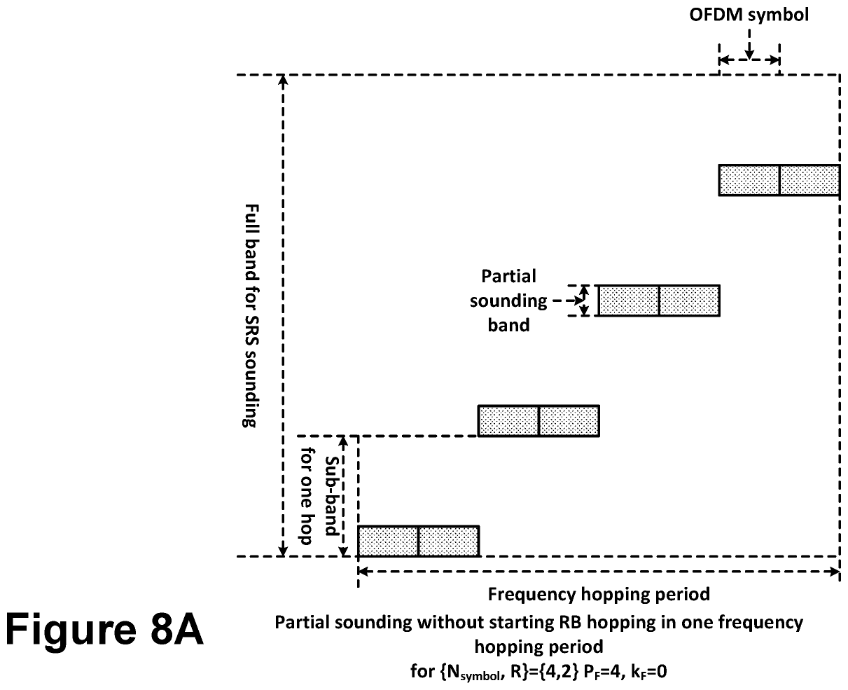

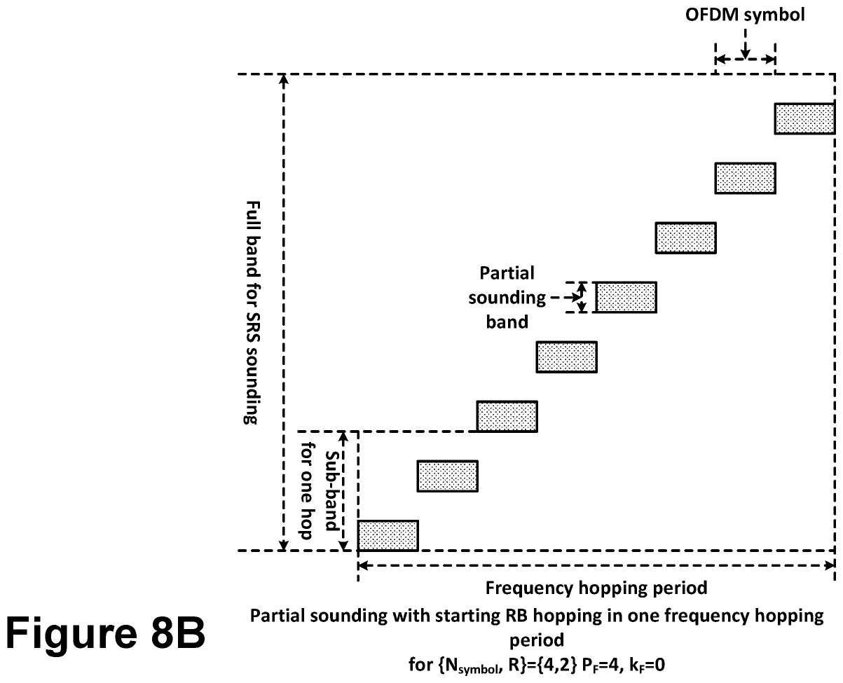

FIGS. 8A and 8B show an example of the operation. In the example, P_{F}=4 is configured, e.g., the sub-band of each hop is divided into 4 parts. {N_{symbol}, R}=(4,2) is configured. In each hop, there are two OFDM symbols. Without starting RB hopping within the frequency hopping period, the same set of sub-carriers are used for SRS transmission in each hop. With starting RB hopping within the frequency hopping period, different set of sub-carriers are used for SRS transmission in each hop.

In another embodiment, for (i+1)-th symbol (i={0, . . . R−1}, R>1) within each hop, the starting RB position could be determined by

$${N}_{offset , i} = \frac{i mod {P}_{F}}{{P}_{F}} {m}_{SRS , {B}_{SRS}} . if R \geq {P}_{F} .$$

If R<P_{F}, the starting RB position for (i+1)-th symbol within each hop could be determined by

$${N}_{offset , i} = \frac{i mod {P}_{F}}{{P}_{F}} {m}_{SRS , {B}_{SRS}} .$$

Or it could be determined by

$${N}_{offset , i} = \frac{( i * \frac{{P}_{F}}{R} ) mod {P}_{F}}{{P}_{F}} {m}_{SRS , {B}_{SRS}} .$$

In another example, (i+1)-th symbol could be interpreted as (i+1)-th symbol within the SRS resource, e.g., i={0, . . . N_{symbol}−1}.

In another embodiment, the starting RB position within each hopping period could be determined considering the starting RB hopping across different hopping period. For example, for (i+1)-th symbol (i={0, . . . R−1}, R>1) within each hop, the starting RB position could be determined by

$${N}_{offset} = \frac{( {k}_{F} + {k}_{hopping} ) mod {P}_{F}}{{P}_{F}} {m}_{SRS , {B}_{SRS}} .$$

In another example, (i+1)-th symbol could be interpreted as (i+1)-th symbol within the SRS resource, e.g., i={0, . . . N_{symbol}−1}.

In another embodiment, the partial sounding with starting RB hopping could be applied within one frequency hopping period for periodic/semi-persistent SRS when the repetition factor R equal to one. Or the partial sounding with starting RB hopping could be for aperiodic SRS when the repetition factor R equal to one.

### Systems and Implementations

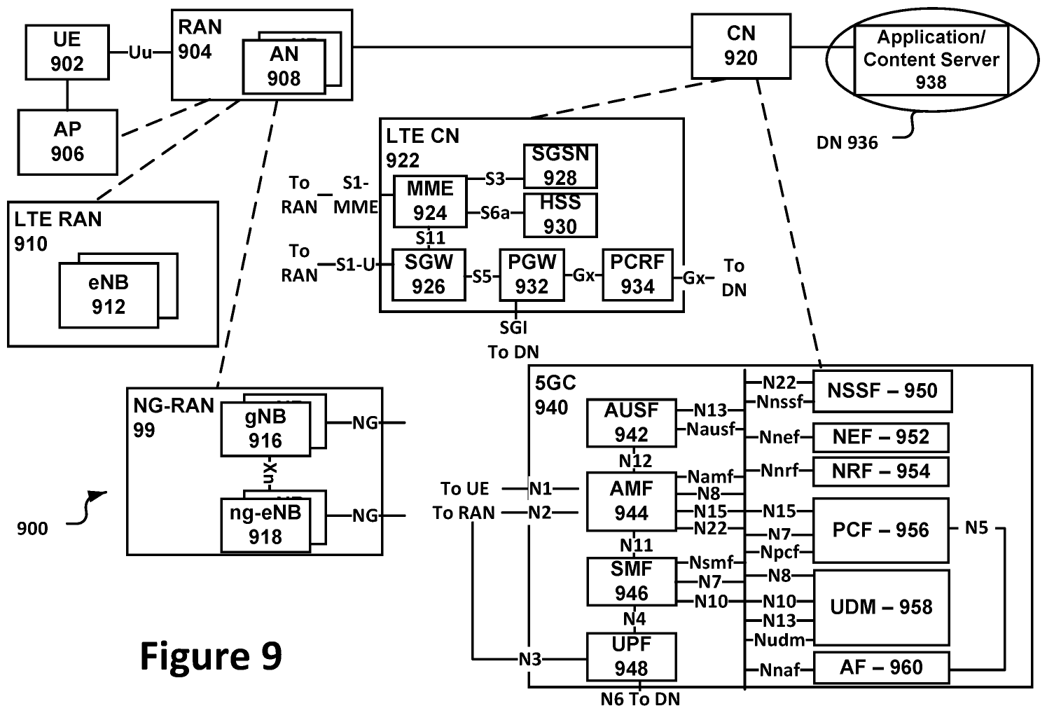

FIGS. 9-11 illustrate various systems, devices, and components that may implement aspects of disclosed embodiments.

FIG. 9 illustrates a network 900 in accordance with various embodiments. The network 900 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 900 may include a UE 902, which may include any mobile or non-mobile computing device designed to communicate with a RAN 904 via an over-the-air connection. The UE 902 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 900 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 902 may additionally communicate with an AP 906 via an over-the-air connection. The AP 906 may manage a WLAN connection, which may serve to offload some/all network traffic from the RAN 904. The connection between the UE 902 and the AP 906 may be consistent with any IEEE 802.11 protocol, wherein the AP 906 could be a wireless fidelity (Wi-Fi®) router. In some embodiments, the UE 902, RAN 904, and AP 906 may utilize cellular-WLAN aggregation (for example, LWA/LWIP). Cellular-WLAN aggregation may involve the UE 902 being configured by the RAN 904 to utilize both cellular radio resources and WLAN resources.

The RAN 904 may include one or more access nodes, for example, AN 908. AN 908 may terminate air-interface protocols for the UE 902 by providing access stratum protocols including RRC. PDCP, RLC, MAC, and LI protocols. In this manner, the AN 908 may enable data/voice connectivity between CN 920 and the UE 902. In some embodiments, the AN 908 may be implemented in a discrete device or as one or more software entities running on server computers as part of, for example, a virtual network, which may be referred to as a CRAN or virtual baseband unit pool. The AN 908 be referred to as a BS, gNB, RAN node, eNB, ng-eNB, NodeB, RSU, TRxP. TRP, etc. The AN 908 may be a macrocell base station or a low power base station for providing femtocells, picocells or other like cells having smaller coverage areas, smaller user capacity, or higher bandwidth compared to macrocells.

In embodiments in which the RAN 904 includes a plurality of ANs, they may be coupled with one another via an X2 interface (if the RAN 904 is an LTE RAN) or an Xn interface (if the RAN 904 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 904 may each manage one or more cells, cell groups, component carriers, etc. to provide the UE 902 with an air interface for network access. The UE 902 may be simultaneously connected with a plurality of cells provided by the same or different ANs of the RAN 904. For example, the UE 902 and RAN 904 may use carrier aggregation to allow the UE 902 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 904 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 902 or AN 908 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 904 may be an LTE RAN 910 with eNBs, for example, eNB 912. The LTE RAN 910 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHZ bands.

In some embodiments, the RAN 904 may be an NG-RAN 914 with gNBs, for example, gNB 916, or ng-eNBs, for example, ng-eNB 918. The gNB 916 may connect with 5G-enabled UEs using a 5G NR interface. The gNB 916 may connect with a 5G core through an NG interface, which may include an N2 interface or an N3 interface. The ng-eNB 918 may also connect with the 5G core through an NG interface, but may connect with a UE via an LTE air interface. The gNB 916 and the ng-eNB 918 may connect with each other over an Xn interface.

In some embodiments, the NG interface may be split into two parts, an NG user plane (NG-U) interface, which carries traffic data between the nodes of the NG-RAN 914 and a UPF 948 (e.g., N3 interface), and an NG control plane (NG-C) interface, which is a signaling interface between the nodes of the NG-RAN 914 and an AMF 944 (e.g., N2 interface).

The NG-RAN 914 may provide a 5G-NR air interface with the following characteristics: variable SCS; CP-OFDM for DL. CP-OFDM and DFT-s-OFDM for UL; polar, repetition, simplex, and Reed-Muller codes for control and LDPC for data. The 5G-NR air interface may rely on CSI-RS. PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHZ. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 902 can be configured with multiple BWPs where each BWP configuration has a different SCS. When a BWP change is indicated to the UE 902, the SCS of the transmission is changed as well. Another use case example of BWP is related to power saving. In particular, multiple BWPs can be configured for the UE 902 with different amount of frequency resources (for example, PRBs) to support data transmission under different traffic loading scenarios. A BWP containing a smaller number of PRBs can be used for data transmission with small traffic load while allowing power saving at the UE 902 and in some cases at the gNB 916. A BWP containing a larger number of PRBs can be used for scenarios with higher traffic load.

The RAN 904 is communicatively coupled to CN 920 that includes network elements to provide various functions to support data and telecommunications services to customers/subscribers (for example, users of UE 902). The components of the CN 920 may be implemented in one physical node or separate physical nodes. In some embodiments. NFV may be utilized to virtualize any or all of the functions provided by the network elements of the CN 920 onto physical compute/storage resources in servers, switches, etc. A logical instantiation of the CN 920 may be referred to as a network slice, and a logical instantiation of a portion of the CN 920 may be referred to as a network sub-slice.

In some embodiments, the CN 920 may be an LTE CN 922, which may also be referred to as an EPC. The LTE CN 922 may include MME 924. SGW 926. SGSN 928. HSS 930, PGW 932, and PCRF 934 coupled with one another over interfaces (or “reference points”) as shown. Functions of the elements of the LTE CN 922 may be briefly introduced as follows.

The MME 924 may implement mobility management functions to track a current location of the UE 902 to facilitate paging, bearer activation/deactivation, handovers, gateway selection, authentication, etc.

The SGW 926 may terminate an SI interface toward the RAN and route data packets between the RAN and the LTE CN 922. The SGW 926 may be a local mobility anchor point for inter-RAN node handovers and also may provide an anchor for inter-3GPP mobility. Other responsibilities may include lawful intercept, charging, and some policy enforcement.

The SGSN 928 may track a location of the UE 902 and perform security functions and access control. In addition, the SGSN 928 may perform inter-EPC node signaling for mobility between different RAT networks; PDN and S-GW selection as specified by MME 924; MME selection for handovers; etc. The S3 reference point between the MME 924 and the SGSN 928 may enable user and bearer information exchange for inter-3GPP access network mobility in idle/active states.

The HSS 930 may include a database for network users, including subscription-related information to support the network entities' handling of communication sessions. The HSS 930 can provide support for routing/roaming, authentication, authorization, naming/addressing resolution, location dependencies, etc. An S6a reference point between the HSS 930 and the MME 924 may enable transfer of subscription and authentication data for authenticating/authorizing user access to the LTE CN 920.

The PGW 932 may terminate an SGi interface toward a data network (DN) 936 that may include an application/content server 938. The PGW 932 may route data packets between the LTE CN 922 and the data network 936. The PGW 932 may be coupled with the SGW 926 by an S5 reference point to facilitate user plane tunneling and tunnel management. The PGW 932 may further include a node for policy enforcement and charging data collection (for example, PCEF). Additionally, the SGi reference point between the PGW 932 and the data network 936 may be an operator external public, a private PDN, or an intra-operator packet data network, for example, for provision of IMS services. The PGW 932 may be coupled with a PCRF 934 via a Gx reference point.

The PCRF 934 is the policy and charging control element of the LTE CN 922. The PCRF 934 may be communicatively coupled to the app/content server 938 to determine appropriate Qos and charging parameters for service flows. The PCRF 932 may provision associated rules into a PCEF (via Gx reference point) with appropriate TFT and QCI.

In some embodiments, the CN 920 may be a 5GC 940. The 5GC 940 may include an AUSF 942, AMF 944, SMF 946, UPF 948, NSSF 950, NEF 952, NRF 954, PCF 956, UDM 958, and AF 960 coupled with one another over interfaces (or “reference points”) as shown. Functions of the elements of the 5GC 940 may be briefly introduced as follows.

The AUSF 942 may store data for authentication of UE 902 and handle authentication-related functionality. The AUSF 942 may facilitate a common authentication framework for various access types. In addition to communicating with other elements of the 5GC 940 over reference points as shown, the AUSF 942 may exhibit an Nausf service-based interface.

The AMF 944 may allow other functions of the 5GC 940 to communicate with the UE 902 and the RAN 904 and to subscribe to notifications about mobility events with respect to the UE 902. The AMF 944 may be responsible for registration management (for example, for registering UE 902), connection management, reachability management, mobility management, lawful interception of AMF-related events, and access authentication and authorization. The AMF 944 may provide transport for SM messages between the UE 902 and the SMF 946, and act as a transparent proxy for routing SM messages. AMF 944 may also provide transport for SMS messages between UE 902 and an SMSF. AMF 944 may interact with the AUSF 942 and the UE 902 to perform various security anchor and context management functions. Furthermore. AMF 944 may be a termination point of a RAN CP interface, which may include or be an N2 reference point between the RAN 904 and the AMF 944; and the AMF 944 may be a termination point of NAS (N1) signaling, and perform NAS ciphering and integrity protection. AMF 944 may also support NAS signaling with the UE 902 over an N3 IWF interface.

The SMF 946 may be responsible for SM (for example, session establishment, tunnel management between UPF 948 and AN 908); UE IP address allocation and management (including optional authorization); selection and control of UP function; configuring traffic steering at UPF 948 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 944 over N2 to AN 908; and determining SSC mode of a session. SM may refer to management of a PDU session, and a PDU session or “session” may refer to a PDU connectivity service that provides or enables the exchange of PDUs between the UE 902 and the data network 936.

The UPF 948 may act as an anchor point for intra-RAT and inter-RAT mobility, an external PDU session point of interconnect to data network 936, and a branching point to support multi-homed PDU session. The UPF 948 may also perform packet routing and forwarding, perform packet inspection, enforce the user plane part of policy rules, lawfully intercept packets (UP collection), perform traffic usage reporting, perform QoS handling for a user plane (e.g., packet filtering, gating. UL/DL rate enforcement), perform uplink traffic verification (e.g., SDF-to-QoS flow mapping), transport level packet marking in the uplink and downlink, and perform downlink packet buffering and downlink data notification triggering. UPF 948 may include an uplink classifier to support routing traffic flows to a data network.

The NSSF 950 may select a set of network slice instances serving the UE 902. The NSSF 950 may also determine allowed NSSAI and the mapping to the subscribed S-NSSAIs, if needed. The NSSF 950 may also determine the AMF set to be used to serve the UE 902, or a list of candidate AMFs based on a suitable configuration and possibly by querying the NRF 954. The selection of a set of network slice instances for the UE 902 may be triggered by the AMF 944 with which the UE 902 is registered by interacting with the NSSF 950, which may lead to a change of AMF. The NSSF 950 may interact with the AMF 944 via an N22 reference point; and may communicate with another NSSF in a visited network via an N31 reference point (not shown). Additionally, the NSSF 950 may exhibit an Nnssf service-based interface.

The NEF 952 may securely expose services and capabilities provided by 3GPP network functions for third party, internal exposure/re-exposure. AFs (e.g., AF 960), edge computing or fog computing systems, etc. In such embodiments, the NEF 952 may authenticate, authorize, or throttle the AFs. NEF 952 may also translate information exchanged with the AF 960 and information exchanged with internal network functions. For example, the NEF 952 may translate between an AF-Service-Identifier and an internal 5GC information. NEF 952 may also receive information from other NFs based on exposed capabilities of other NFs. This information may be stored at the NEF 952 as structured data, or at a data storage NF using standardized interfaces. The stored information can then be re-exposed by the NEF 952 to other NFs and AFs. or used for other purposes such as analytics. Additionally, the NEF 952 may exhibit an Nnef service-based interface.

The NRF 954 may support service discovery functions, receive NF discovery requests from NF instances, and provide the information of the discovered NF instances to the NF instances. NRF 954 also maintains information of available NF instances and their supported services. As used herein, the terms “instantiate.” “instantiation.” and the like may refer to the creation of an instance, and an “instance” may refer to a concrete occurrence of an object, which may occur, for example, during execution of program code. Additionally, the NRF 954 may exhibit the Nnrf service-based interface.

The PCF 956 may provide policy rules to control plane functions to enforce them, and may also support unified policy framework to govern network behavior. The PCF 956 may also implement a front end to access subscription information relevant for policy decisions in a UDR of the UDM 958. In addition to communicating with functions over reference points as shown, the PCF 956 exhibit an Npcf service-based interface.

The UDM 958 may handle subscription-related information to support the network entities' handling of communication sessions, and may store subscription data of UE 902. For example, subscription data may be communicated via an N8 reference point between the UDM 958 and the AMF 944. The UDM 958 may include two parts, an application front end and a UDR. The UDR may store subscription data and policy data for the UDM 958 and the PCF 956, and/or structured data for exposure and application data (including PFDs for application detection, application request information for multiple UEs 902) for the NEF 952. The Nudr service-based interface may be exhibited by the UDR 221 to allow the UDM 958. PCF 956, and NEF 952 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 958 may exhibit the Nudm service-based interface.

The AF 960 may provide application influence on traffic routing, provide access to NEF, and interact with the policy framework for policy control.

In some embodiments, the 5GC 940 may enable edge computing by selecting operator/3^{rd} party services to be geographically close to a point that the UE 902 is attached to the network. This may reduce latency and load on the network. To provide edge-computing implementations, the 5GC 940 may select a UPF 948 close to the UE 902 and execute traffic steering from the UPF 948 to data network 936 via the N6 interface. This may be based on the UE subscription data, UE location, and information provided by the AF 960. In this way, the AF 960 may influence UPF (re)selection and traffic routing. Based on operator deployment, when AF 960 is considered to be a trusted entity, the network operator may permit AF 960 to interact directly with relevant NFs. Additionally, the AF 960 may exhibit an Naf service-based interface.

The data network 936 may represent various network operator services, Internet access, or third party services that may be provided by one or more servers including, for example, application/content server 938.

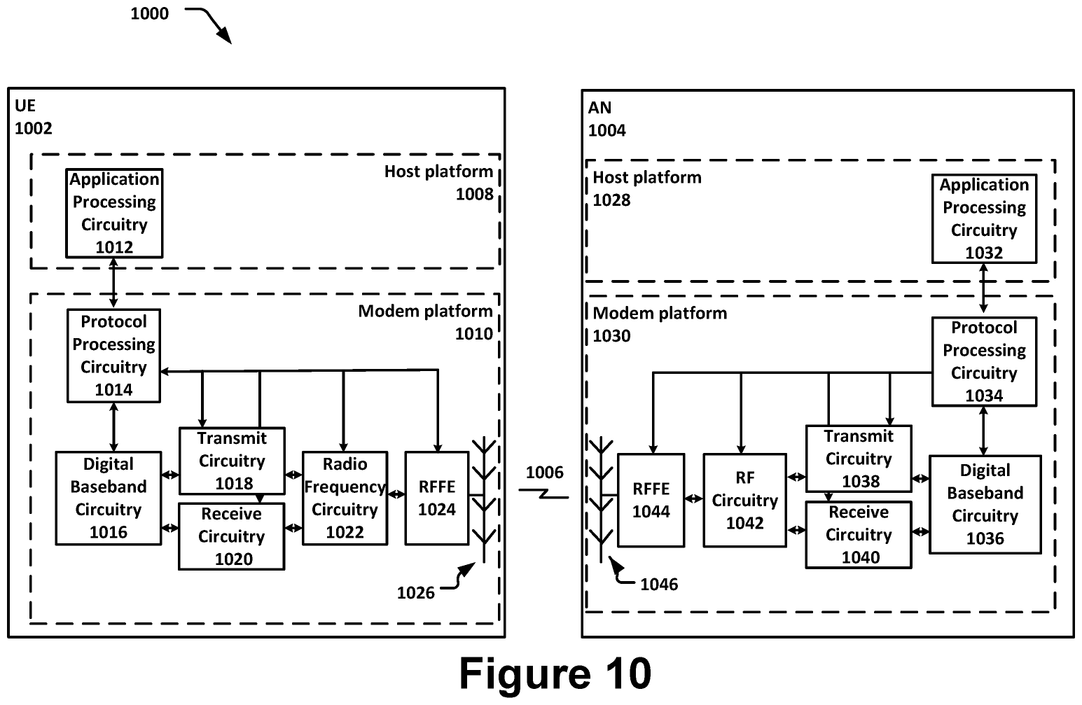

FIG. 10 schematically illustrates a wireless network 1000 in accordance with various embodiments. The wireless network 1000 may include a UE 1002 in wireless communication with an AN 1004. The UE 1002 and AN 1004 may be similar to, and substantially interchangeable with, like-named components described elsewhere herein.

The UE 1002 may be communicatively coupled with the AN 1004 via connection 1006. The connection 1006 is illustrated as an air interface to enable communicative coupling, and can be consistent with cellular communications protocols such as an LTE protocol or a 5G NR protocol operating at mmWave or sub-6 GHZ frequencies.

The UE 1002 may include a host platform 1008 coupled with a modem platform 1010. The host platform 1008 may include application processing circuitry 1012, which may be coupled with protocol processing circuitry 1014 of the modem platform 1010. The application processing circuitry 1012 may run various applications for the UE 1002 that source/sink application data. The application processing circuitry 1012 may further implement one or more layer operations to transmit/receive application data to/from a data network. These layer operations may include transport (for example UDP) and Internet (for example, IP) operations

The protocol processing circuitry 1014 may implement one or more of layer operations to facilitate transmission or reception of data over the connection 1006. The layer operations implemented by the protocol processing circuitry 1014 may include, for example, MAC, RLC, PDCP. RRC and NAS operations.

The modem platform 1010 may further include digital baseband circuitry 1016 that may implement one or more layer operations that are “below” layer operations performed by the protocol processing circuitry 1014 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 1010 may further include transmit circuitry 1018, receive circuitry 1020, RF circuitry 1022, and RF front end (RFFE) 1024, which may include or connect to one or more antenna panels 1026. Briefly, the transmit circuitry 1018 may include a digital-to-analog converter, mixer, intermediate frequency (IF) components, etc.; the receive circuitry 1020 may include an analog-to-digital converter, mixer, IF components, etc.; the RF circuitry 1022 may include a low-noise amplifier, a power amplifier, power tracking components, etc.; RFFE 1024 may include filters (for example, surface/bulk acoustic wave filters), switches, antenna tuners, beamforming components (for example, phase-array antenna components), etc. The selection and arrangement of the components of the transmit circuitry 1018, receive circuitry 1020, RF circuitry 1022, RFFE 1024, and antenna panels 1026 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 1014 may include one or more instances of control circuitry (not shown) to provide control functions for the transmit/receive components.

A UE reception may be established by and via the antenna panels 1026, RFFE 1024, RF circuitry 1022, receive circuitry 1020, digital baseband circuitry 1016, and protocol processing circuitry 1014. In some embodiments, the antenna panels 1026 may receive a transmission from the AN 1004 by receive-beamforming signals received by a plurality of antennas/antenna elements of the one or more antenna panels 1026.

A UE transmission may be established by and via the protocol processing circuitry 1014, digital baseband circuitry 1016, transmit circuitry 1018, RF circuitry 1022, RFFE 1024, and antenna panels 1026. In some embodiments, the transmit components of the UE 1004 may apply a spatial filter to the data to be transmitted to form a transmit beam emitted by the antenna elements of the antenna panels 1026.

Similar to the UE 1002, the AN 1004 may include a host platform 1028 coupled with a modem platform 1030. The host platform 1028 may include application processing circuitry 1032 coupled with protocol processing circuitry 1034 of the modem platform 1030. The modem platform may further include digital baseband circuitry 1036, transmit circuitry 1038, receive circuitry 1040, RF circuitry 1042, RFFE circuitry 1044, and antenna panels 1046. The components of the AN 1004 may be similar to and substantially interchangeable with like-named components of the UE 1002. In addition to performing data transmission/reception as described above, the components of the AN 1008 may perform various logical functions that include, for example, RNC functions such as radio bearer management, uplink and downlink dynamic radio resource management, and data packet scheduling.

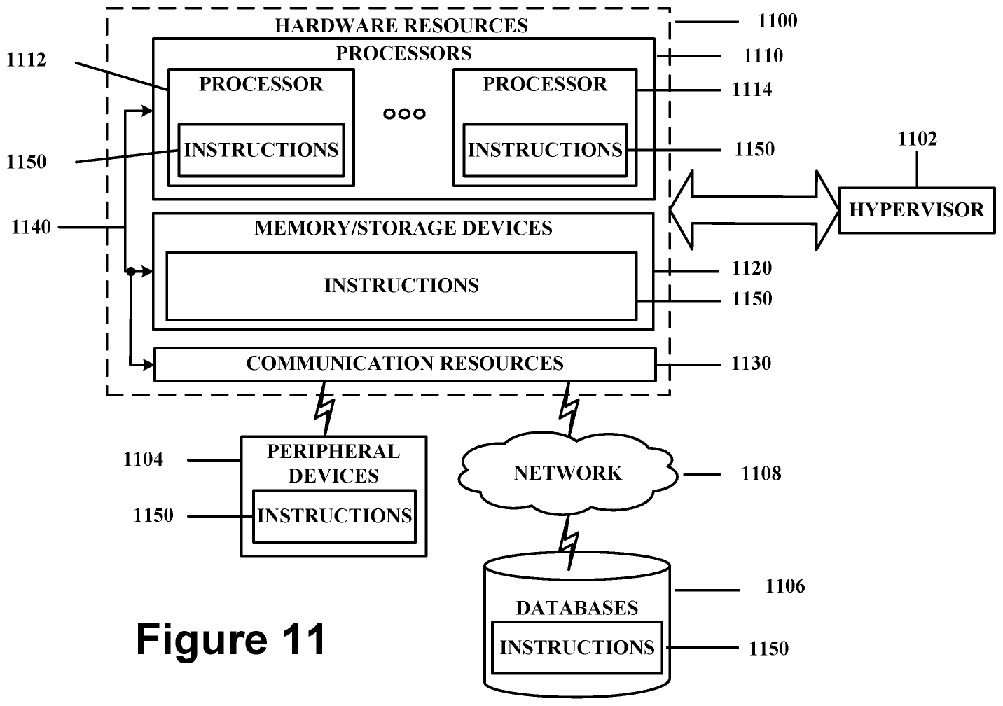

FIG. 11 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 11 shows a diagrammatic representation of hardware resources 1100 including one or more processors (or processor cores) 1110, one or more memory/storage devices 1120, and one or more communication resources 1130, each of which may be communicatively coupled via a bus 1140 or other interface circuitry. For embodiments where node virtualization (e.g., NFV) is utilized, a hypervisor 1102 may be executed to provide an execution environment for one or more network slices/sub-slices to utilize the hardware resources 1100.

The processors 1110 may include, for example, a processor 1112 and a processor 1114. The processors 1110 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radiofrequency integrated circuit (RFIC), another processor (including those discussed herein), or any suitable combination thereof.

The memory/storage devices 1120 may include main memory, disk storage, or any suitable combination thereof. The memory/storage devices 1120 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1130 may include interconnection or network interface controllers, components, or other suitable devices to communicate with one or more peripheral devices 1104 or one or more databases 1106 or other network elements via a network 1108. For example, the communication resources 1130 may include wired communication components (e.g., for coupling via USB, Ethernet, etc.), cellular communication components, NFC components, Bluetooth® (or Bluetooth® Low Energy) components, Wi-Fi® components, and other communication components.

Instructions 1150 may comprise software, a program, an application, an applet, an app, or other executable code for causing at least any of the processors 1110 to perform any one or more of the methodologies discussed herein. The instructions 1150 may reside, completely or partially, within at least one of the processors 1110 (e.g., within the processor's cache memory), the memory/storage devices 1120, or any suitable combination thereof. Furthermore, any portion of the instructions 1150 may be transferred to the hardware resources 1100 from any combination of the peripheral devices 1104 or the databases 1106. Accordingly, the memory of processors 1110, the memory/storage devices 1120, the peripheral devices 1104, and the databases 1106 are examples of computer-readable and machine-readable media.

### Example Procedures

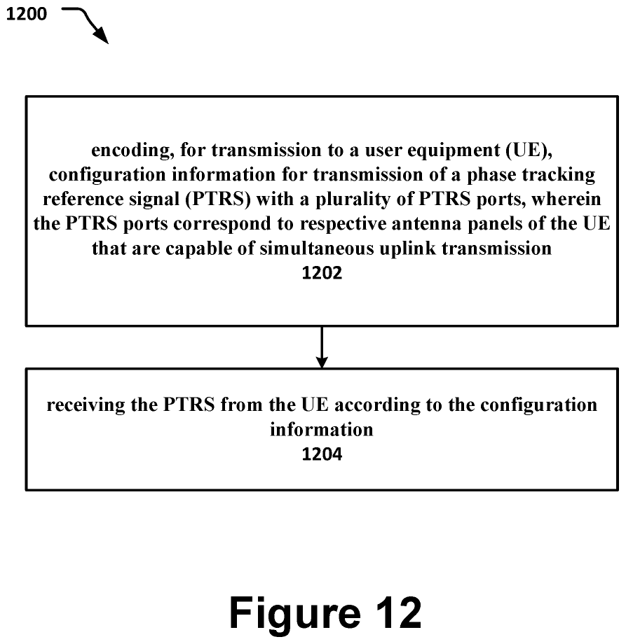

In some embodiments, the electronic device(s), network(s), system(s), chip(s) or component(s), or portions or implementations thereof, of FIGS. 9-11, or some other figure herein, may be configured to perform one or more processes, techniques, or methods as described herein, or portions thereof. One such process 1200 is depicted in FIG. 12. In embodiments, the process 1200 may be performed by a gNB or a portion thereof. At 1202, the process 1200 may include encoding, for transmission to a user equipment (UE), configuration information for transmission of a phase tracking reference signal (PTRS) with a plurality of PTRS ports, wherein the PTRS ports correspond to respective antenna panels of the UE that are capable of simultaneous uplink transmission. At 1204, the process 1200 may further include receiving the PTRS from the UE according to the configuration information.

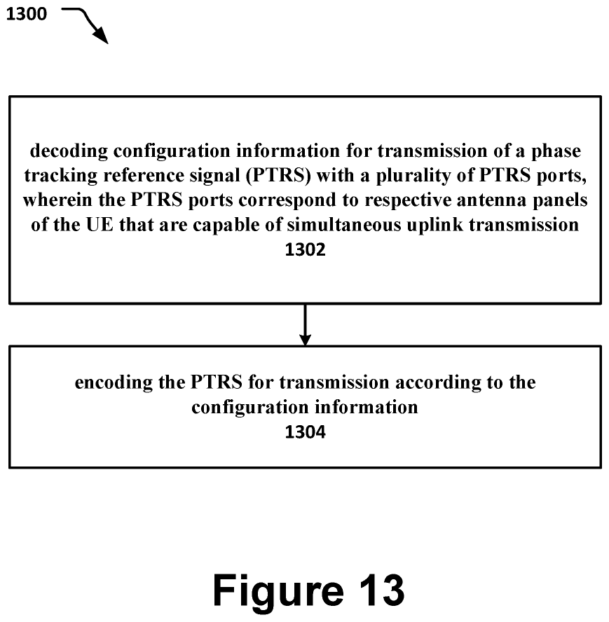

FIG. 13 illustrates another process 1300 in accordance with various embodiments. In embodiments, the process 1300 may be performed by a UE or a portion thereof. At 1302, the process 1300 may include decoding configuration information for transmission of a phase tracking reference signal (PTRS) with a plurality of PTRS ports, wherein the PTRS ports correspond to respective antenna panels of the UE that are capable of simultaneous uplink transmission. At 1304, the process 1300 may further include encoding the PTRS for transmission according to the configuration information.

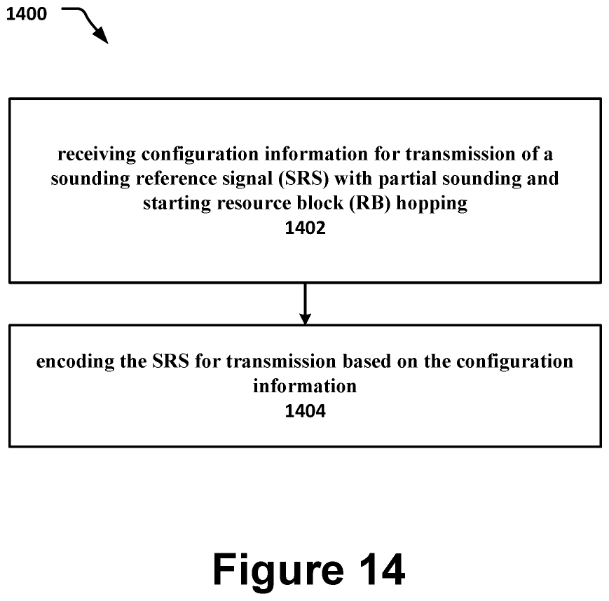

FIG. 14 illustrates another process 1400 in accordance with various embodiments. In embodiments, the process 1400 may be performed by a UE or a portion thereof. At 1402, the process 1400 may include receiving configuration information for transmission of a sounding reference signal (SRS) with partial sounding and starting resource block (RB) hopping. At 1404, the process may further include encoding the SRS for transmission based on the configuration information.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example A1 may include one or more computer-readable media (CRM) having instructions, stored thereon, that when executed by one or more processors configure a next generation Node B (gNB) to: encode, for transmission to a user equipment (UE), configuration information for transmission of a phase tracking reference signal (PTRS) with a plurality of PTRS ports, wherein the PTRS ports correspond to respective antenna panels of the UE that are capable of simultaneous uplink transmission; and receive the PTRS from the UE according to the configuration information.

Example A2 may include the one or more CRM of example A1, wherein the instructions, when executed, are further to configure the gNB to encode, for transmission to the UE, sounding reference signal (SRS) configuration information for codebook-based or non-codebook-based uplink transmission, wherein the SRS configuration information includes multiple SRS resource sets that correspond to respective antenna panels of the UE or a single SRS resource set that corresponds to two or more of the antenna panels.

Example A3 may include the one or more CRM of example A1, wherein the instructions, when executed, are further to configure the gNB to encode a downlink control information (DCI) for transmission to the UE to schedule a physical uplink shared channel (PUSCH), wherein the DCI indicates sounding reference signal (SRS) resource indicators (SRIs) that correspond to respective antenna panels of the UE.

Example A4 may include the one or more CRM of example A3, wherein the DCI further indicates one or multiple transmission precoding matrix indicators (TPMI) for the PUSCH.

Example A5 may include the one or more CRM of example A1, wherein each of the PTRS ports is associated with a subset of physical uplink shared channel (PUSCH) ports.

Example A6 may include the one or more CRM of example A1, wherein the instructions, when executed, are further to configure the gNB to encode a downlink control information (DCI) for transmission to the UE to schedule the uplink transmission, wherein the DCI indicates PTRS-demodulation reference signal (DMRS) associations for the respective PTRS ports.

Example A7 may include the one or more CRM of example A6, wherein the DCI includes a PTRS-DMRS field with 3 or 4 bits to indicate the PTRS-DMRS associations, or separate PTRS-DMRS fields to indicate the respective PTRS-DMRS associations.

Example A8 may include the one or more CRM of any one of examples A1-A7, wherein the instructions, when executed, are further to cause the gNB to determine a parameter k_{ref}^{RE} that indicates a reference resource element position based on a respective demodulation reference signal (DMRS) antenna port of eight DMRS ports and a respective offset value of four offset values, wherein the PTRS is mapped to a frequency resource based on the parameter k_{ref}^{RE}.

Example A9 may include the one or more CRM of any one of examples A1-A7, wherein the configuration information is for codebook-based uplink transmission or non-codebook-based uplink transmission.

Example A10 may include one or more computer-readable media (CRM) having instructions, stored thereon, that when executed by one or more processors configure a user equipment (UE) to: decode configuration information for transmission of a phase tracking reference signal (PTRS) with a plurality of PTRS ports, wherein the PTRS ports correspond to respective antenna panels of the UE that are capable of simultaneous uplink transmission; and encode the PTRS for transmission according to the configuration information.

Example A11 may include the one or more CRM of example A10, wherein the instructions, when executed, are further to configure the UE to decode sounding reference signal (SRS) configuration information for codebook-based or non-codebook-based uplink transmission, wherein the SRS configuration information includes multiple SRS resource sets that correspond to respective antenna panels of the UE or a single SRS resource set that corresponds to two or more of the antenna panels.

Example A12 may include the one or more CRM of example A10, wherein the instructions, when executed, are further to configure the UE to decode a downlink control information (DCI) to schedule a physical uplink shared channel (PUSCH), wherein the DCI indicates sounding reference signal (SRS) resource indicators (SRIs) that correspond to respective antenna panels of the UE.

Example A13 may include the one or more CRM of example A12, wherein the DCI further indicates one or multiple transmission precoding matrix indicators (TPMI) for the PUSCH.

Example A14 may include the one or more CRM of example A10, wherein each of the PTRS ports is associated with a subset of physical uplink shared channel (PUSCH) ports.

Example A15 may include the one or more CRM of example A10, wherein the instructions, when executed, are further to configure the UE to decode a downlink control information (DCI) for transmission to the UE to schedule the uplink transmission, wherein the DCI indicates PTRS-demodulation reference signal (DMRS) associations for the respective PTRS ports.

Example A16 may include the one or more CRM of example A15, wherein the DCI includes a PTRS-DMRS field with 3 or 4 bits to indicate the PTRS-DMRS associations, or separate PTRS-DMRS fields to indicate the respective PTRS-DMRS associations.

Example A17 may include the one or more CRM of any one of examples A10-A16, wherein the instructions, when executed, are further to cause the UE to determine a parameter k_{ref}^{RE} ref that indicates a reference resource element position based on a respective demodulation reference signal (DMRS) antenna port of eight DMRS ports and a respective offset value of four offset values, wherein the PTRS is mapped to a frequency resource based on the parameter k_{ref}^{RE}.

Example A18 may include the one or more CRM of any one of examples A10-A16, wherein the configuration information is for codebook-based uplink transmission or non-codebook-based uplink transmission.

Example A19 may include one or more computer-readable media (CRM) having instructions, stored thereon, that when executed by one or more processors configure a user equipment (UE) to: receive configuration information for transmission of a sounding reference signal (SRS) with partial sounding and starting resource block (RB) hopping; and encode the SRS for transmission based on the configuration information.

Example A20 may include the one or more CRM of example A19, wherein the starting RB hopping is performed within one frequency hopping period of the SRS.

Example A21 may include the one or more CRM of example A19, wherein the starting RB hopping is performed for the SRS with a repetition factor greater than one.

Example A22 may include the one or more CRM of example A19, wherein the SRS has a number of symbols N_{symbol}∈{1, 2, 4, 8, 10, 12, 14} and a repetition factor of R, wherein the starting RB hopping is applied with a number of hops N_{Hop} given by N_{Hop}=N_{symbol}/R, wherein individual hops include R symbols.

Example A23 may include the one or more CRM of example A19, wherein over different symbols within individual hops, the SRS is transmitted over a same set of sub-carriers, and wherein, for different hops, the SRS is transmitted over different sets of sub-carriers.

Example A24 may include the one or more CRM of any one of examples A19-A23, wherein the SRS is a periodic SRS, a semi-persistent SRS, or an aperiodic SRS.

Example B1 may include a method of a gNB, wherein the gNB configures the UE with PTRS for uplink transmission.

Example B2 may include the method of example B1 or some other example herein, wherein if the number of simultaneous active panel of the UE for uplink transmission is N, then the number of PTRS ports is extended to N. Each PTRS port is mapped to each UE antenna panel. This could be applied to all the uplink waveforms, such as CP-OFDM and DFT-s-OFDM.

Example B3 may include the method of example B2 or some other example herein, wherein for codebook based uplink transmission, multiple SRS resource sets could be configured, and each SRS resource set corresponds to one UE antenna panel.

Example B4 may include the method of example B3 or some other example herein, wherein in the DCI scheduling PUSCH transmission, multiple SRI fields could be included, and each SRI corresponds to one UE antenna panel. Correspondingly, multiple TPMI fields could be included, and each TPMI field correspond to one UE antenna panel. In such case, each TPMI corresponds to one PTRS port.

Example B5 may include the method of example B2 or some other example herein, wherein for codebook based uplink transmission, only one SRS resource set could be configured to the UE and only one TPMI field is signaled to the UE in the DCI.

Example B6 may include the method of example B5 or some other example herein, wherein if the UE can support simultaneous transmission from multiple panels, and the number of PTRS ports is N, for example, N=4, then each PTRS port is associated with a subset of the PSUCH ports.

Example B7 may include the method of example B2 or some other example herein, wherein the PTRS-DMRS field should be extended. Or multiple PTRS-DMRS field should be included in the scheduling DCI.

Example B8 may include the method of example B2 or some other example herein, wherein for non-codebook based uplink transmission, the RRC parameter ptrs-PortIndex should be extended to support more PTRS ports. For example, the value of ptrs-PortIndex should be extended to {1, 2, 3, 4} to support 4-port PTRS operation.

Example B9 may include the method of example B2 or some other example herein, wherein for non-codebook based uplink transmission, multiple SRS resource sets could be configured to the UE which can support simultaneous transmission from multiple panels. Each SRS resource set corresponds to one UE antenna panel. Each antenna panel is associated with one PTRS port. The SRS resources within one SRS resource set should be associated with the same PTRS port index.

Example B10 may include a method comprising: encoding, for transmission to a UE, configuration information for transmission of a PTRS, wherein a number of PTRS ports is equal to a number of simultaneous active antenna panels of the UE for uplink transmission; and receiving the PTRS from the UE according to the configuration information.

Example B11 may include the method of example B10 or some other example herein, wherein the PTRS is a CP-OFDM waveform or a DFT-s-OFDM waveform.

Example B12 may include the method of example B10-B11 or some other example herein, further comprising encoding, for transmission to the UE, SRS configuration information for codebook based uplink transmission, wherein the SRS configuration information includes multiple SRS resource sets that correspond to respective antenna panels of the UE.

Example B13 may include the method of example B10-B12 or some other example herein, further comprising encoding a DCI for transmission the UE to schedule a PUSCH, wherein the DCI includes multiple SRI fields that correspond to respective antenna panels of the UE.

Example B14 may include the method of example B13 or some other example herein, wherein the DCI further includes multiple TPMI fields that correspond to respective antenna panels.

Example B15 may include the method of example B14 or some other example herein, wherein each TPMI corresponds to one PTRS port.

Example B16 may include the method of example B10-B11 or some other example herein, further comprising configuring only one SRS resource set for the UE for codebook based uplink transmission.

Example B17 may include the method of example B16 or some other example herein, further comprising encoding a DCI for transmission to the UE to schedule a PUSCH, wherein the DCI includes only one TPMI field.

Example B18 may include the method of example B17 or some other example herein, wherein the UE supports simultaneous transmission from multiple panels, and wherein each PTRS port is associated with a subset of PUSCH ports.

Example B19 may include the method of example B10-B18 or some other example herein, wherein the scheduling DCI includes one or more PTRS-DMRS fields to configuration a plurality of PTRS-DMRSs for respective PTRS ports.

Example B20 may include the method of example B10-B11 or some other example herein, wherein non-codebook based uplink transmission is used, and wherein the method further comprises encoding, for transmission to the UE, RRC parameter ptrs-PortIndex to support 4 or more PTRS ports.

Example B21 may include the method of example B10-B11 or some other example herein, wherein non-codebook based uplink transmission is used, and wherein the method further comprises configuring multiple SRS resource sets for the UE to support simultaneous transmission from multiple antenna panels.

Example B22 may include the method of example B21 or some other example herein, wherein each SRS resource set corresponds to one UE antenna panel.

Example B23a may include the method of example B22 or some other example herein, wherein each antenna panel is associated with one PTRS port.

Example B23b may include the method of example B21-B23a or some other example herein, wherein the SRS resources within one SRS resource set are associated with the same PTRS port index.

Example B24a may include the method of example 10-23b or some other example herein, wherein the PTRS ports are mapped to PUSCH ports according to FIG. 2 herein.

Example B24b may include the method of example B10-B23b or some other example herein, wherein the PTRS ports are mapped to PUSCH ports according to FIG. 3 herein.

Example B24c may include the method of example B10-B24b or some other example herein, wherein the configuration information includes a PTRS-DMRS field in a DCI.

Example B24d may include the method of example B24c or some other example herein, wherein the PTRS-DMRS field includes 3 or 4 bits.

Example B24e may include the method of example B24c-d or some other example herein, wherein the PTRS-DMRS field supports transmission with up to 8 Tx ports and/or with multiple antenna panels.

Example B24f may include the method of example B24c-e or some other example herein, wherein the PTRS-DMRS field is according to any of Tables 1-6 herein.

Example B24g may include the method of example B10-B24f or some other example herein, further comprising: determining a parameter k_{ref}^{RE} according to Table 7 herein; and generating a PTRS sequence and mapping a PTRS to a frequency resource based on the parameter k_{ref}^{RE}.

Example B25 may include the method of example B10-B24g or some other example herein, wherein the method is performed by a gNB or a portion thereof.

Example B26 may include a method of a UE, the method comprising:
receiving configuration information for transmission of a PTRS, wherein a number of PTRS ports is equal to a number of simultaneous active antenna panels of the UE for uplink transmission; and
encoding the PTRS for transmission according to the configuration information.

Example B27 may include the method of example B26 or some other example herein, wherein the PTRS is a CP-OFDM waveform or a DFT-s-OFDM waveform.

Example B28 may include the method of example B26-B27 or some other example herein, further comprising receiving SRS configuration information for codebook based uplink transmission, wherein the SRS configuration information includes multiple SRS resource sets that correspond to respective antenna panels of the UE.

Example B29 may include the method of example B26-B28 or some other example herein, further comprising receiving a DCI to schedule a PUSCH, wherein the DCI includes multiple SRI fields that correspond to respective antenna panels of the UE.

Example B30 may include the method of example B29 or some other example herein, wherein the DCI further includes multiple TPMI fields that correspond to respective antenna panels.

Example B31 may include the method of example B30 or some other example herein, wherein each TPMI corresponds to one PTRS port.

Example B32 may include the method of example B26-B27 or some other example herein, wherein only one SRS resource set is configured for the UE for codebook based uplink transmission.

Example B33 may include the method of example B32 or some other example herein, further comprising receiving a DCI to schedule a PUSCH, wherein the DCI includes only one TPMI field.

Example B34 may include the method of example B33 or some other example herein, wherein the UE supports simultaneous transmission from multiple panels, and wherein each PTRS port is associated with a subset of PUSCH ports.

Example B35 may include the method of example B26-B34 or some other example herein, wherein the scheduling DCI includes one or more PTRS-DMRS fields to configuration a plurality of PTRS-DMRSs for respective PTRS ports.

Example B36 may include the method of example B26-B27 or some other example herein, wherein non-codebook based uplink transmission is used, and wherein the method further comprises receiving a RRC parameter ptrs-PortIndex to support 4 or more PTRS ports.

Example B37 may include the method of example B26-B27 or some other example herein, wherein non-codebook based uplink transmission is used, and wherein the method further comprises receiving SRS configuration information for multiple SRS resource sets to support simultaneous transmission from multiple antenna panels.

Example B38 may include the method of example B37 or some other example herein, wherein each SRS resource set corresponds to one UE antenna panel.

Example B39 may include the method of example B38 or some other example herein, wherein each antenna panel is associated with one PTRS port.

Example B40 may include the method of example B37-B39 or some other example herein, wherein the SRS resources within one SRS resource set are associated with the same PTRS port index.

Example B41 may include the method of example B26-B40 or some other example herein, wherein the PTRS ports are mapped to PUSCH ports according to FIG. 2 herein.

Example B42 may include the method of example B26-B41 or some other example herein, wherein the PTRS ports are mapped to PUSCH ports according to FIG. 3 herein.

Example B43 may include the method of example B26-B41 or some other example herein, wherein the configuration information includes a PTRS-DMRS field in a DCI.

Example B44 may include the method of example B43 or some other example herein, wherein the PTRS-DMRS field includes 3 or 4 bits.

Example B45 may include the method of example B43-B44 or some other example herein, wherein the PTRS-DMRS field supports transmission with up to 8 Tx ports and/or with multiple antenna panels.

Example B46 may include the method of example B43-B45 or some other example herein, wherein the PTRS-DMRS field is according to any of Tables 1-6 herein.

Example B47 may include the method of example B26-B46 or some other example herein, further comprising: determining a parameter k_{ref}^{RE} according to Table 7 herein; and generating a PTRS sequence and mapping a PTRS to a frequency resource based on the parameter k_{ref}^{RE}.

Example C1 may include a method wherein the gNB configures the UE to transmit SRS with frequency hopping and partial sounding.

Example C2 may include the method of example C1 or some other example herein, wherein for SRS with number of symbols N_{symbol}∈{1, 2, 4, 8, 10, 12, 14} and repetition factor of R, the frequency hopping could be applied. The number of hops N_{Hop} is given by N_{Hop}=N_{symbol}/R. Each hop includes R OFDM symbols. Over different symbols within each hop, the SRS is transmitted over the same set of sub-carriers. For different hop, the SRS is transmitted over different set of sub-carriers. For periodic SRS and semi-persistent SRS, inter-slot hopping and intra-slot hopping could be supported. For aperiodic SRS, intra-slot frequency hopping is supported.

Example C3 may include the method of example C1 or some other example herein, wherein for SRS with number of symbols N_{symbol}∈{1, 2, 4, 8, 10, 12, 14} and repetition factor of R, when partial sounding is applied, the starting RB hopping could be applied within one frequency hopping period for periodic/semi-persistent SRS. Or the starting RB hopping could be applied for aperiodic SRS.

Example C4 may include the method of example C3 or some other example herein, wherein the partial sounding with starting RB hopping could be applied within one frequency hopping period for periodic/semi-persistent SRS when the repetition factor R is larger than one. Or the partial sounding with starting RB hopping could be for aperiodic SRS when the repetition factor R is larger than one.

Example C5 may include the method of example C4, wherein for (i+1)-th symbol (i={0, . . . R−1}, R>1) within each hop, the starting RB position could be determined by

$${N}_{offset , i} = \frac{i mod {P}_{F}}{{P}_{F}} {m}_{SRS , {B}_{SRS}} . if R \geq {P}_{F} .$$

Example C6 may include the method of example C4 or some other example herein, wherein if R<P_{F}, the starting RB position for (i+1)-th symbol within each hop could be determined by

$${N}_{offset , i} = \frac{i mod {P}_{F}}{{P}_{F}} {m}_{SRS , {B}_{SRS}} .$$

Or it could be determined by

$${N}_{offset , i} = \frac{( i * \frac{{P}_{F}}{R} ) mod {P}_{F}}{{P}_{F}} {m}_{SRS , {B}_{SRS}} .$$

Example C7 may include the method of example C4 or some other example herein, wherein the starting RB position within each hopping period could be determined considering the starting RB hopping across different hopping period. For example, for (i+1)-th symbol (i={0, . . . R−1}, R>1) within each hop, the starting RB position could be determined by

$${N}_{offset} = \frac{( {k}_{F} + {k}_{hopping} ) mod {P}_{F}}{{P}_{F}} {m}_{SRS , {B}_{SRS}} .$$

Example C8 may include the method of example C3 or some other example herein, wherein the partial sounding with starting RB hopping could be applied within one frequency hopping period for periodic/semi-persistent SRS when the repetition factor R equal to one. Or the partial sounding with starting RB hopping could be for aperiodic SRS when the repetition factor R equal to one.

Example C9 may include a method of a UE, the method comprising:
receiving configuration information for transmission of a sounding reference signal (SRS) with frequency hopping and partial sounding; and
encoding the SRS for transmission based on the configuration information.

Example C10 may include the method of example C9 or some other example herein, wherein the SRS has a number of symbols N_{symbol}∈{1, 2, 4, 8, 10, 12, 14} and a repetition factor of R.

Example C11 may include the method of example C10 or some other example herein, wherein the frequency hopping is applied with a number of hops N_{Hop} given by N_{Hop}=N_{symbol}/R, wherein each hop includes R OFDM symbols.

Example C12 may include the method of example C11 or some other example herein, wherein over different symbols within each hop, the SRS is transmitted over the same set of sub-carriers.

Example C13 may include the method of example C11-C12 or some other example herein, wherein for different hops, the SRS is transmitted over different set of sub-carriers.

Example C14 may include the method of example C9-C13 or some other example herein, wherein the configuration information supports inter-slot and intra-slot hopping for periodic SRS and/or semi-persistent SRS, and/or intra-slot hopping for aperiodic SRS.

Example C15 may include the method of example C10-C14 or some other example herein, wherein partial sounding is applied and a starting RB hopping is applied within one frequency hopping period for periodic/semi-persistent SRS, or the starting RB hopping is applied for aperiodic SRS.

Example C16 may include the method of example C15 or some other example herein, wherein the partial sounding with starting RB hopping is applied within one frequency hopping period for periodic/semi-persistent SRS when the repetition factor R is larger than 1, or the partial sounding with starting RB hopping is applied for aperiodic SRS when the repetition factor R is larger than 1.

Example Z01 may include an apparatus comprising means to perform one or more elements of a method described in or related to any of examples 1-47, C1-C15, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1-47, C1-C15, or any other method or process described herein.

Example Z03 may include an apparatus comprising logic, modules, or circuitry to perform one or more elements of a method described in or related to any of examples 1-47, C1-C15, or any other method or process described herein.

Example Z04 may include a method, technique, or process as described in or related to any of examples 1-47, C1-C15, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1-47, C1-C15, or portions thereof.

Example Z06 may include a signal as described in or related to any of examples 1-47, or portions or parts thereof.

Example Z07 may include a datagram, packet, frame, segment, protocol data unit (PDU), or message as described in or related to any of examples 1-47, C1-C15, or portions or parts thereof, or otherwise described in the present disclosure.

Example Z08 may include a signal encoded with data as described in or related to any of examples 1-47, C1-C15, or portions or parts thereof, or otherwise described in the present disclosure.

Example Z09 may include a signal encoded with a datagram, packet, frame, segment, protocol data unit (PDU), or message as described in or related to any of examples 1-47, C1-C15, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1-47, C1-C15, or portions thereof.

Example Z11 may include a computer program comprising instructions, wherein execution of the program by a processing element is to cause the processing element to carry out the method, techniques, or process as described in or related to any of examples 1-47, C1-C15, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v 16.0.0 (2019-06). For the purposes of the present document, the following abbreviations may apply to the examples and embodiments discussed herein.

| | |
|---|---|
| 3GPP | Third |
| | Generation |
| | Partnership |
| | Project |
| 4G | Fourth |
| | Generation |
| 5G | Fifth |
| | Generation |
| 5GC | 5G Core |
| | network |
| AC | Application |
| | Client |
| ACR | Application |
| | Context |
| | Relocation |
| ACK | Acknowledgement |
| ACID | Application |
| | Client Identification |
| AF | Application |
| | Function |
| AM | Acknowledged |
| | Mode |
| AMBR | Aggregate |
| | Maximum Bit Rate |
| AMF | Access and |
| | Mobility |
| | Management |
| | Function |
| AN | Access |
| | Network |
| ANR | Automatic |
| | Neighbour Relation |
| AOA | Angle of |
| | Arrival |
| AP | Application |
| | Protocol, Antenna |
| | Port, Access Point |
| API | Application |
| | Programming Interface |
| APN | Access Point |
| | Name |
| ARP | Allocation and |
| | Retention Priority |
| ARQ | Automatic |
| | Repeat Request |
| AS | Access Stratum |
| ASP | Application |
| | Service |
| | Provider |
| ASN.1 | Abstract Syntax |
| | Notation One |
| AUSF | Authentication |
| | Server Function |
| AWGN | Additive |
| | White Gaussian |
| | Noise |
| BAP | Backhaul |
| | Adaptation |
| | Protocol |
| BCH | Broadcast |
| | Channel |
| BER | Bit Error Ratio |
| BFD | Beam |
| | Failure Detection |
| BLER | Block Error Rate |
| BPSK | Binary Phase |
| | Shift Keying |
| BRAS | Broadband |
| | Remote Access |
| | Server |
| BSS | Business |
| | Support System |
| BS | Base Station |
| BSR | Buffer Status |
| | Report |
| BW | Bandwidth |
| BWP | Bandwidth Part |
| C-RNTI | Cell |
| | Radio Network |
| | Temporary |
| | Identity |
| CA | Carrier |
| | Aggregation, |
| | Certification |
| | Authority |
| CAPEX | CAPital |
| | EXpenditure |
| | CBRA Contention |
| | Based Random |
| | Access |
| CC | Component |
| | Carrier, Country |
| | Code, Cryptographic |
| | Checksum |
| CCA | Clear Channel |
| | Assessment |
| CCE | Control |
| | Channel Element |
| CCCH | Common |
| | Control Channel |
| CE | Coverage |
| | Enhancement |
| CDM | Content |
| | Delivery Network |
| CDMA | Code- |
| | Division Multiple |
| | Access |
| CDR | Charging Data |
| | Request |
| CDR | Charging Data |
| | Response |
| CFRA | Contention Free |
| | Random Access |
| CG | Cell Group |
| CGF | Charging |
| | Gateway Function |
| CHF | Charging |
| | Function |
| CI | Cell Identity |
| CID | Cell-ID (e.g., |
| | positioning method) |
| CIM | Common |
| | Information Model |
| CIR | Carrier to |
| | Interference Ratio |
| CK | Cipher Key |
| CM | Connection |
| | Management, |
| | Conditional |
| | Mandatory |
| CMAS | Commercial |
| Mobile | Alert Service |
| CMD | Command |
| CMS | Cloud |
| | Management System |
| CO | Conditional |
| | Optional |
| CoMP | Coordinated |
| | Multi-Point |
| CORESET | Control |
| | Resource Set |
| COTS | Commercial |
| | Off-The-Shelf |
| CP | Control Plane, |
| | Cyclic Prefix, |
| | Connection |
| | Point |
| CPD | Connection |
| | Point Descriptor |
| CPE | Customer |
| | Premise |
| | Equipment |
| CPICH | Common Pilot |
| | Channel |
| CQI | Channel |
| | Quality Indicator |
| CPU | CSI processing |
| | unit, Central |
| | Processing Unit |
| C/R | Command/Response |
| | field bit |
| CRAN | Cloud Radio |
| | Access |
| | Network, Cloud |
| | RAN |
| CRB | Common |
| | Resource Block |
| CRC | Cyclic |
| | Redundancy Check |
| CRI | Channel-State |
| | Information |
| | Resource |
| | Indicator, CSI-RS |
| | Resource |
| | Indicator |
| C-RNTI | Cell |
| | RNTI |
| CS | Circuit |
| | Switched |
| CSCF | call |
| | session control function |
| CSAR | Cloud Service |
| | Archive |
| CSI | Channel-State |
| | Information |
| CSI-IM | CSI |
| | Interference |
| | Measurement |
| CSI-RS CSI | Reference Signal |
| CSI-RSRP CSI | reference signal |
| | received power |
| CSI-RSRQ CSI | reference signal |
| | received quality |
| CSI-SINR CSI | signal-to-noise and |
| | interference |
| | ratio |
| CSMA | Carrier Sense |
| | Multiple Access |
| CSMA/CA | CSMA |
| | with collision |
| | avoidance |
| CSS | Common |
| | Search Space, Cell- |
| | specific Search |
| | Space |
| CTF | Charging |
| | Trigger Function |
| CTS | Clear-to-Send |
| CW | Codeword |
| CWS | Contention |
| | Window Size |
| D2D | Device-to- |
| | Device |
| DC | Dual |
| | Connectivity, Direct |
| | Current |
| DCI | Downlink |
| | Control |
| | Information |
| DF | Deployment |
| | Flavour |
| DL | Downlink |
| DMTF | Distributed |
| | Management Task |
| | Force |
| DPDK | Data Plane |
| | Development Kit |
| DM-RS, | DMRS |
| | Demodulation |
| | Reference Signal |
| DN | Data network |
| DNN | Data Network |
| | Name |
| DNAI | Data Network |
| | Access Identifier |
| DRB | Data Radio |
| | Bearer |
| DRS | Discovery |
| | Reference Signal |
| | DRX Discontinuous |
| | Reception |
| DSL | Domain |
| | Specific Language. |
| | Digital |
| | Subscriber Line |
| DSLAM | DSL |
| | Access Multiplexer |
| DwPTS | Downlink Pilot |
| | Time Slot |
| E-LAN | Ethernet |
| | Local Area Network |
| E2E | End-to-End |
| EAS | Edge |
| | Application Server |
| ECCA | extended clear |
| | channel |
| | assessment, |
| | extended CCA |
| ECCE | Enhanced |
| | Control Channel |
| | Element, |
| | Enhanced CCE |
| ED | Energy |
| | Detection |
| EDGE | Enhanced |
| | Datarates for GSM |
| | Evolution |
| | (GSM Evolution) |
| EAS | Edge |
| | Application Server |
| EASID | Edge |
| | Application Server |
| | Identification |
| ECS | Edge |
| | Configuration Server |
| ECSP | Edge |
| | Computing Service |
| | Provider |
| EDN | Edge |
| | Data Network |
| EEC | Edge |
| | Enabler Client |
| EECID | Edge |
| | Enabler Client |
| | Identification |
| EES | Edge |
| | Enabler Server |
| EESID | Edge |
| | Enabler Server |
| | Identification |
| EHE | Edge |
| | Hosting Environment |
| EGMF | Exposure |
| | Governance |
| | Management |
| | Function |
| EGPRS | Enhanced |
| | GPRS |
| EIR | Equipment |
| | Identity Register |
| eLAA | enhanced |
| | Licensed Assisted |
| | Access, |
| | enhanced LAA |
| EM | Element |
| | Manager |
| eMBB | Enhanced |
| | Mobile |
| | Broadband |
| EMS | Element |
| | Management System |
| eNB | evolved NodeB, |
| E-UTRAN | Node B |
| EN-DC | E-UTRA-NR Dual |
| | Connectivity |
| EPC | Evolved Packet |
| | Core |
| EPDCCH | enhanced |
| | PDCCH, enhanced |
| | Physical |
| | Downlink Control |
| | Cannel |
| EPRE | Energy per |
| | resource element |
| EPS | Evolved Packet |
| | System |
| EREG | enhanced REG, |
| | enhanced resource |
| | element groups |
| ETSI | European |
| | Telecommunications |
| | Standards |
| | Institute |
| ETWS | Earthquake and |
| | Tsunami Warning |
| | System |
| eUICC | embedded |
| UICC, | embedded |
| | Universal |
| | Integrated Circuit |
| | Card |
| E-UTRA | Evolved |
| | UTRA |
| E-UTRAN | Evolved |
| | UTRAN |
| EV2X | Enhanced V2X |
| F1AP F1 | Application |
| | Protocol |
| F1-C | F1 Control |
| | plane interface |
| F1-U F1 | User plane |
| | interface |
| FACCH | Fast |
| | Associated Control |
| | CHannel |
| FACCH/F | Fast |
| | Associated Control |
| | Channel/Full |
| | rate |
| FACCH/H | Fast |
| | Associated Control |
| | Channel/Half |
| | rate |
| FACH | Forward Access |
| | Channel |
| FAUSCH | Fast |
| | Uplink Signalling |
| | Channel |
| FB | Functional |
| | Block |
| FBI | Feedback |
| | Information |
| FCC | Federal |
| | Communications |
| | Commission |
| FCCH | Frequency |
| | Correction CHannel |
| FDD | Frequency |
| | Division Duplex |
| FDM | Frequency |
| | Division |
| | Multiplex |
| FDMA | Frequency |
| | Division Multiple |
| | Access |
| FE | Front End |
| FEC | Forward Error |
| | Correction |
| FFS | For Further |
| | Study |
| FFT | Fast Fourier |
| | Transformation |
| feLAA | further |
| | enhanced Licensed |
| | Assisted |
| | Access, further |
| | enhanced LAA |
| FN | Frame Number |
| FPGA | Field- |
| | Programmable Gate |
| | Array |
| FR | Frequency |
| | Range |
| FQDN | Fully |
| | Qualified Domain |
| | Name |
| G-RNTI | GERAN |
| | Radio Network |
| | Temporary |
| | Identity |
| | GERAN |
| GSM EDGE | Radio Access |
| RAN, GSM EDGE | Network |
| GGSN | Gateway GPRS |
| | Support Node |
| GLONASS | GLObal'naya |
| | NAvigatsionnaya |
| | Sputnikovaya |
| | Sistema (Engl.: |
| | Global Navigation |
| | Satellite |
| | System) |
| gNB | Next |
| | Generation NodeB |
| gNB-CU | gNB- |
| | centralized unit, Next |
| | Generation |
| | NodeB |
| | centralized unit |
| gNB-DU | gNB- |
| | distributed unit, Next |
| | Generation |
| | NodeB |
| | distributed unit |
| GNSS | Global |
| | Navigation Satellite |
| | System |
| GPRS | General Packet |
| | Radio Service |
| GPSI | Generic |
| | Public Subscription |
| | Identifier |
| | GSM Global System |
| | for Mobile |
| | Communications, |
| | Groupe Special |
| | Mobile |
| GTP | GPRS |
| | Tunneling Protocol |
| GTP-UGPRS | Tunnelling Protocol |
| | for User Plane |
| GTS | Go To Sleep |
| | Signal (related |
| | to WUS) |
| GUMMEI | Globally |
| | Unique MME |
| | Identifier |
| GUTI | Globally |
| | Unique Temporary |
| | UE Identity |
| HARQ | Hybrid ARQ, |
| | Hybrid |
| | Automatic |
| | Repeat Request |
| HANDO | Handover |
| HFN | HyperFrame |
| | Number |
| HHO | Hard Handover |
| HLR | Home Location |
| | Register |
| HN | Home Network |
| HO | Handover |
| HPLMN | Home |
| | Public Land Mobile |
| | Network |
| HSDPA | High |
| | Speed Downlink |
| | Packet Access |
| HSN | Hopping |
| | Sequence Number |
| HSPA | High Speed |
| | Packet Access |
| HSS | Home |
| | Subscriber Server |
| HSUPA | High |
| | Speed Uplink Packet |
| | Access |
| HTTP | Hyper Text |
| | Transfer Protocol |
| HTTPS | Hyper |
| | Text Transfer Protocol |
| | Secure (https is |
| | http/1.1 over |
| | SSL, i.e. port 443) |
| I-Block | Information |
| | Block |
| ICCID | Integrated |
| | Circuit Card |
| | Identification |
| IAB | Integrated |
| | Access and |
| | Backhaul |
| ICIC | Inter-Cell |
| | Interference |
| | Coordination |
| ID | Identity, |
| | identifier |
| IDFT | Inverse Discrete |
| | Fourier |
| | Transform |
| IE | Information |
| | element |
| IBE | In-Band |
| | Emission |
| IEEE | Institute of |
| | Electrical and |
| | Electronics |
| | Engineers |
| IEI | Information |
| | Element |
| | Identifier |
| IEIDL | Information |
| | Element |
| | Identifier Data |
| | Length |
| IETF | Internet |
| | Engineering Task |
| | Force |
| IF | Infrastructure |
| IIOT | Industrial |
| | Internet of Things |
| IM | Interference |
| | Measurement, |
| | Intermodulation |
| IP | Multimedia |
| IMC | IMS |
| | Credentials |
| IMEI | International |
| | Mobile |
| | Equipment |
| | Identity |
| IMGI | International |
| | mobile group identity |
| IMPI | IP Multimedia |
| | Private Identity |
| IMPU | IP Multimedia |
| | PUblic identity |
| IMS | IP Multimedia |
| | Subsystem |
| IMSI | International |
| | Mobile |
| | Subscriber |
| | Identity |
| IoT | Internet of |
| | Things |
| IP | Internet |
| | Protocol |
| Ipsec | IP Security, |
| | Internet Protocol |
| | Security |
| IP-CAN | IP- |
| | Connectivity Access |
| | Network |
| IP-M | IP Multicast |
| IPv4 | Internet |
| | Protocol Version 4 |
| IPv6 | Internet |
| | Protocol Version 6 |
| IR | Infrared |
| IS | In Sync |
| IRP | Integration |
| | Reference Point |
| ISDN | Integrated |
| | Services Digital |
| | Network |
| ISIM | IM Services |
| | Identity Module |
| ISO | International |
| | Organisation for |
| | Standardisation |
| ISP | Internet Service |
| | Provider |
| IWF | Interworking- |
| | Function |
| I-WLAN | Interworking |
| | WLAN |
| | Constraint |
| | length of the |
| | convolutional |
| | code, USIM |
| | Individual key |
| kB | Kilobyte (1000 |
| | bytes) |
| kbps | kilo-bits per |
| | second |
| Kc | Ciphering key |
| Ki | Individual |
| | subscriber |
| | authentication |
| | key |
| KPI | Key |
| | Performance Indicator |
| KQI | Key Quality |
| | Indicator |
| KSI | Key Set |
| | Identifier |
| ksps | kilo-symbols |
| | per second |
| KVM | Kernel Virtual |
| | Machine |
| L1 | Layer 1 |
| | (physical layer) |
| L1-RSRP | Layer 1 |
| | reference signal |
| | received power |
| L2 | Layer 2 (data |
| | link layer) |
| L3 | Layer 3 |
| | (network layer) |
| LAA | Licensed |
| | Assisted Access |
| LAN | Local Area |
| | Network |
| LADN | Local |
| | Area Data Network |
| LBT | Listen Before |
| | Talk |
| LCM | LifeCycle |
| | Management |
| LCR | Low Chip Rate |
| LCS | Location |
| | Services |
| LCID | Logical |
| | Channel ID |
| LI | Layer Indicator |
| LLC | Logical Link |
| | Control, Low Layer |
| | Compatibility |
| LMF | Location |
| | Management Function |
| LOS | Line of |
| | Sight |
| LPLMN | Local |
| | PLMN |
| LPP | LTE |
| | Positioning Protocol |
| LSB | Least |
| | Significant Bit |
| LTE | Long Term |
| | Evolution |
| LWA | LTE-WLAN |
| | aggregation |
| LWIP | LTE/WLAN |
| | Radio Level |
| | Integration with |
| | IPsec Tunnel |
| LTE | Long Term |
| | Evolution |
| M2M | Machine-to- |
| | Machine |
| MAC | Medium Access |
| | Control |
| | (protocol |
| | layering context) |
| MAC | Message |
| | authentication code |
| | (security/encryption |
| | context) |
| MAC-A | MAC |
| | used for |
| | authentication |
| | and key |
| | agreement |
| | (TSG T WG3 context) |
| MAC-IMAC | used for |
| | data integrity of |
| | signalling messages |
| | (TSG T WG3 context) |
| MANO | Management |
| | and Orchestration |
| MBMS | Multimedia |
| | Broadcast and |
| | Multicast |
| | Service |
| MBSFN | Multimedia |
| | Broadcast |
| | multicast |
| | service Single |
| | Frequency |
| | Network |
| MCC | Mobile Country |
| | Code |
| MCG | Master Cell |
| | Group |
| MCOT | Maximum |
| | Channel |
| | Occupancy |
| | Time |
| MCS | Modulation and |
| | coding scheme |
| MDAF | Management |
| | Data Analytics |
| | Function |
| MDAS | Management |
| | Data Analytics |
| | Service |
| MDT | Minimization of |
| | Drive Tests |
| ME | Mobile |
| | Equipment |
| MeNB | master eNB |
| MER | Message Error |
| | Ratio |
| MGL | Measurement |
| | Gap Length |
| MGRP | Measurement |
| | Gap Repetition |
| | Period |
| MIB | Master |
| | Information Block, |
| | Management |
| | Information Base |
| MIMO | Multiple Input |
| | Multiple Output |
| MLC | Mobile |
| | Location Centre |
| MM | Mobility |
| | Management |
| MME | Mobility |
| | Management Entity |
| MN | Master Node |
| MNO | Mobile |
| | Network Operator |
| MO | Measurement |
| | Object, Mobile |
| | Originated |
| MPBCH | MTC |
| | Physical Broadcast |
| | CHannel |
| MPDCCH | MTC |
| | Physical Downlink |
| | Control |
| | CHannel |
| MPDSCH | MTC |
| | Physical Downlink |
| | Shared |
| | CHannel |
| MPRACH | MTC |
| | Physical Random |
| | Access |
| | CHannel |
| MPUSCH | MTC |
| | Physical Uplink Shared |
| | Channel |
| MPLS | MultiProtocol |
| | Label Switching |
| | MS Mobile Station |
| MSB | Most |
| | Significant Bit |
| MSC | Mobile |
| | Switching Centre |
| MSI | Minimum |
| | System |
| | Information, |
| MCH | Scheduling |
| | Information |
| MSID | Mobile Station |
| | Identifier |
| MSIN | Mobile Station |
| | Identification |
| | Number |
| MSISDN | Mobile |
| | Subscriber ISDN |
| | Number |
| MT | Mobile |
| | Terminated, Mobile |
| | Termination |
| MTC | Machine-Type |
| | Communications |
| mMTC | massive MTC, |
| | massive |
| | Machine-Type |
| | Communications |
| MU-MIMO | Multi |
| | User MIMO |
| MWUS | MTC |
| | wake-up signal, MTC |
| | WUS |
| NACK | Negative |
| | Acknowledgement |
| NAI | Network |
| | Access Identifier |
| NAS | Non-Access |
| | Stratum, Non-Access |
| | Stratum layer |
| NCT | Network |
| | Connectivity |
| | Topology |
| NC-JT | Non- |
| | Coherent Joint |
| | Transmission |
| | NEC Network |
| | Capability |
| | Exposure |
| NE-DC | NR-E- |
| | UTRA Dual |
| | Connectivity |
| NEF | Network |
| | Exposure Function |
| NF | Network |
| | Function |
| NFP | Network |
| | Forwarding Path |
| NFPD | Network |
| | Forwarding Path |
| | Descriptor |
| NFV | Network |
| | Functions |
| | Virtualization |
| NFVI | NFV |
| | Infrastructure |
| NFVO | NFV |
| | Orchestrator |
| NG | Next |
| | Generation, Next Gen |
| NGEN-DC | NG- |
| | RAN E-UTRA-NR |
| | Dual Connectivity |
| NM | Network |
| | Manager |
| NMS | Network |
| | Management System |
| N-POP | Network Point |
| | of Presence |
| NMIB, | N-MIB |
| | Narrowband MIB |
| NPBCH | Narrowband |
| | Physical |
| | Broadcast |
| | CHannel |
| NPDCCH | Narrowband |
| | Physical |
| | Downlink |
| | Control CHannel |
| NPDSCH | Narrowband |
| | Physical |
| | Downlink |
| | Shared CHannel |
| NPRACH | Narrowband |
| | Physical Random |
| | Access CHannel |
| NPUSCH | Narrowband |
| | Physical Uplink |
| | Shared CHannel |
| NPSS | Narrowband |
| | Primary |
| | Synchronization |
| | Signal |
| NSSS | Narrowband |
| | Secondary |
| | Synchronization |
| | Signal |
| NR | New Radio, |
| | Neighbour Relation |
| NRF | NF Repository |
| | Function |
| NRS | Narrowband |
| | Reference Signal |
| NS | Network |
| | Service |
| NSA | Non-Standalone |
| | operation mode |
| NSD | Network |
| | Service Descriptor |
| | NSR Network |
| | Service Record |
| NSSAI | Network Slice |
| | Selection |
| | Assistance |
| | Information |
| S-NNSAI | Single- |
| | NSSAI |
| NSSF | Network Slice |
| | Selection Function |
| NW | Network |
| NWUS | Narrowband |
| | wake-up signal, |
| | Narrowband WUS |
| NZP | Non-Zero |
| | Power |
| O&M | Operation and |
| | Maintenance |
| ODU2 | Optical channel |
| | Data Unit-type 2 |
| OFDM | Orthogonal |
| | Frequency Division |
| | Multiplexing |
| OFDMA | Orthogonal |
| | Frequency Division |
| | Multiple Access |
| OOB | Out-of-band |
| OOS | Out of |
| | Sync |
| OPEX | OPerating |
| | EXpense |
| OSI | Other System |
| | Information |
| OSS | Operations |
| | Support System |
| OTA | over-the-air |
| PAPR | Peak-to- |
| | Average Power |
| | Ratio |
| PAR | Peak to |
| | Average Ratio |
| PBCH | Physical |
| | Broadcast Channel |
| PC | Power Control, |
| | Personal |
| | Computer |
| PCC | Primary |
| | Component Carrier, |
| | Primary CC |
| P-CSCF | Proxy |
| | CSCF |
| PCell | Primary Cell |
| PCI | Physical Cell |
| | ID, Physical Cell |
| | Identity |
| PCEF | Policy and |
| | Charging |
| | Enforcement |
| | Function |
| PCF | Policy Control |
| | Function |
| PCRF | Policy Control |
| | and Charging Rules |
| | Function |
| PDCP | Packet Data |
| | Convergence |
| | Protocol, Packet |
| | Data Convergence |
| | Protocol layer |
| PDCCH | Physical |
| | Downlink Control |
| | Channel |
| PDCP | Packet Data |
| | Convergence Protocol |
| PDN | Packet Data |
| | Network, Public |
| | Data Network |
| PDSCH | Physical |
| | Downlink Shared |
| | Channel |
| PDU | Protocol Data |
| | Unit |
| PEI | Permanent |
| | Equipment |
| | Identifiers |
| PFD | Packet Flow |
| | Description |
| P-GW | PDN Gateway |
| PHICH | Physical |
| | hybrid-ARQ indicator |
| | channel |
| PHY | Physical layer |
| PLMN | Public Land |
| | Mobile Network |
| PIN | Personal |
| | Identification Number |
| PM | Performance |
| | Measurement |
| PMI | Precoding |
| | Matrix Indicator |
| PNF | Physical |
| | Network Function |
| PNFD | Physical |
| | Network Function |
| | Descriptor |
| PNFR | Physical |
| | Network Function |
| | Record |
| POC | PTT over |
| | Cellular |
| PP, PTP | Point-to- |
| | Point |
| PPP | Point-to-Point |
| | Protocol |
| PRACH | Physical |
| | RACH |
| PRB | Physical |
| | resource block |
| PRG | Physical |
| | resource block |
| | group |
| ProSe | Proximity |
| | Services, |
| | Proximity- |
| | Based Service |
| PRS | Positioning |
| | Reference Signal |
| PRR | Packet |
| | Reception Radio |
| PS | Packet Services |
| PSBCH | Physical |
| | Sidelink Broadcast |
| | Channel |
| PSDCH | Physical |
| | Sidelink Downlink |
| | Channel |
| PSCCH | Physical |
| | Sidelink Control |
| | Channel |
| PSSCH | Physical |
| | Sidelink Shared |
| | Channel |
| PSCell | Primary SCell |
| PSS | Primary |
| | Synchronization |
| | Signal |
| PSTN | Public Switched |
| | Telephone Network |
| PT-RS | Phase-tracking |
| | reference signal |
| PTT | Push-to-Talk |
| PUCCH | Physical |
| | Uplink Control |
| | Channel |
| PUSCH | Physical |
| | Uplink Shared |
| | Channel |
| QAM | Quadrature |
| | Amplitude |
| | Modulation |
| QCI | QoS class of |
| | identifier |
| QCL | Quasi co- |
| | location |
| QFI | QOS Flow ID, |
| | QoS Flow |
| | Identifier |
| QoS | Quality of |
| | Service |
| QPSK | Quadrature |
| | (Quaternary) Phase |
| | Shift Keying |
| QZSS | Quasi-Zenith |
| | Satellite System |
| RA-RNTI | Random |
| | Access RNTI |
| RAB | Radio Access |
| | Bearer, Random |
| | Access Burst |
| RACH | Random Access |
| | Channel |
| RADIUS | Remote |
| | Authentication Dial |
| | In User Service |
| RAN | Radio Access |
| | Network |
| RAND | RANDom |
| | number (used for |
| | authentication) |
| RAR | Random Access |
| | Response |
| RAT | Radio Access |
| | Technology |
| RAU | Routing Area |
| | Update |
| RB | Resource block, |
| | Radio Bearer |
| RBG | Resource block |
| | group |
| REG | Resource |
| | Element Group |
| Rel | Release |
| REQ | REQuest |
| RF | Radio |
| | Frequency |
| RI | Rank Indicator |
| RIV | Resource |
| | indicator value |
| RL | Radio Link |
| RLC | Radio Link |
| | Control, Radio |
| | Link Control |
| | layer |
| RLC AM | RLC |
| | Acknowledged Mode |
| RLC UM | RLC |
| | Unacknowledged |
| | Mode |
| RLF | Radio Link |
| | Failure |
| RLM | Radio Link |
| | Monitoring |
| RLM-RS | Reference |
| | Signal for RLM |
| RM | Registration |
| | Management |
| RMC | Reference |
| | Measurement Channel |
| RMSI | Remaining |
| | MSI, Remaining |
| | Minimum |
| | System |
| | Information |
| RN | Relay Node |
| RNC | Radio Network |
| | Controller |
| RNL | Radio Network |
| | Layer |
| RNTI | Radio Network |
| | Temporary |
| | Identifier |
| ROHC | RObust Header |
| | Compression |
| RRC | Radio Resource |
| | Control, Radio |
| | Resource Control |
| | layer |
| RRM | Radio Resource |
| | Management |
| RS | Reference |
| | Signal |
| RSRP | Reference |
| | Signal Received |
| | Power |
| RSRQ | Reference |
| | Signal Received |
| | Quality |
| RSSI | Received Signal |
| | Strength |
| | Indicator |
| RSU | Road Side Unit |
| RSTD | Reference |
| | Signal Time |
| | difference |
| RTP | Real Time |
| | Protocol |
| RTS | Ready-To-Send |
| RTT | Round Trip |
| | Time |
| Rx | Reception, |
| | Receiving, Receiver |
| S1AP | S1 Application |
| | Protocol |
| S1-MME | S1 for |
| | the control plane |
| S1-U | SI for the user |
| | plane |
| S-CSCF | serving |
| | CSCF |
| S-GW | Serving |
| | Gateway |
| S-RNTI | SRNC |
| | Radio Network |
| | Temporary |
| | Identity |
| S-TMSI | SAE |
| | Temporary Mobile |
| | Station |
| | Identifier |
| SA | Standalone |
| | operation mode |
| SAE | System |
| | Architecture |
| | Evolution |
| SAP | Service Access |
| | Point |
| SAPD | Service Access |
| | Point Descriptor |
| SAPI | Service Access |
| | Point Identifier |
| SCC | Secondary |
| | Component Carrier, |
| | Secondary CC |
| SCell | Secondary Cell |
| SCEF | Service |
| | Capability Exposure |
| | Function |
| SC-FDMA | Single |
| | Carrier Frequency |
| | Division |
| | Multiple Access |
| SCG | Secondary Cell |
| | Group |
| SCM | Security |
| | Context |
| | Management |
| SCS | Subcarrier |
| | Spacing |
| SCTP | Stream Control |
| | Transmission |
| | Protocol |
| SDAP | Service Data |
| | Adaptation |
| | Protocol, |
| | Service Data |
| | Adaptation |
| | Protocol layer |
| SDL | Supplementary |
| | Downlink |
| SDNF | Structured Data |
| | Storage Network |
| | Function |
| SDP | Session |
| | Description Protocol |
| SDSF | Structured Data |
| | Storage Function |
| SDT | Small Data |
| | Transmission |
| SDU | Service Data |
| | Unit |
| SEAF | Security |
| | Anchor Function |
| SeNB | secondary eNB |
| SEPP | Security Edge |
| | Protection Proxy |
| SFI | Slot format |
| | indication |
| SFTD | Space- |
| | Frequency Time |
| | Diversity, SFN |
| | and frame timing |
| | difference |
| SFN | System Frame |
| | Number |
| SgNB | Secondary gNB |
| SGSN | Serving GPRS |
| | Support Node |
| S-GW | Serving |
| | Gateway |
| SI | System |
| | Information |
| SI-RNTI | System |
| | Information RNTI |
| SIB | System |
| | Information Block |
| SIM | Subscriber |
| | Identity Module |
| SIP | Session |
| | Initiated Protocol |
| SiP | System in |
| | Package |
| SL | Sidelink |
| SLA | Service Level |
| SM | Session |
| | Management |
| SMF | Session |
| | Management Function |
| SMS | Short Message |
| | Service |
| SMSF | SMS Function |
| SMTC | SSB-based |
| | Measurement Timing |
| | Configuration |
| SN | Secondary |
| | Node, Sequence |
| | Number |
| SoC | System on Chip |
| SON | Self-Organizing |
| | Network |
| | SpCell Special Cell |
| SP-CSI-RNTI | Semi- |
| | Persistent CSI RNTI |
| SPS | Semi-Persistent |
| | Scheduling |
| SQN | Sequence |
| | number |
| SR | Scheduling |
| | Request |
| SRB | Signalling |
| | Radio Bearer |
| SRS | Sounding |
| | Reference Signal |
| SS | Synchronization |
| | Signal |
| SSB | Synchronization |
| | Signal Block |
| SSID | Service Set |
| | Identifier |
| SS/PBCH | Block |
| | SSBRI SS/PBCH |
| | Block Resource |
| | Indicator, |
| | Synchronization |
| | Signal Block |
| | Resource |
| | Indicator |
| SSC | Session and |
| | Service |
| | Continuity |
| SS-RSRP | Synchronization |
| | based |
| | Reference |
| | Signal Received |
| | Power |
| SS-RSRQ | Synchronization |
| | Signal based |
| | Reference |
| | Received |
| | Quality |
| SS-SINR | Synchronization |
| | Signal based Signal |
| | to Noise and |
| | Interference Ratio |
| SSS | Secondary |
| | Synchronization |
| | Signal |
| SSSG | Search Space |
| | Set Group |
| SSSIF | Search Space |
| | Set Indicator |
| SST | Slice/Service |
| | Types |
| SU-MIMO | Single |
| | User MIMO |
| SUL | Supplementary |
| | Uplink |
| TA | Timing |
| | Advance, Tracking |
| | Area |
| TAC | Tracking Area |
| | Code |
| TAG | Timing |
| | Advance Group |
| TAI | |
| | Tracking Area |
| | Identity |
| TAU | Tracking Area |
| | Update |
| TB | Transport Block |
| TBS | Transport Block |
| | Size |
| TBD | To Be Defined |
| TCI | Transmission |
| | Configuration |
| | Indicator |
| TCP | Transmission |
| | Communication |
| | Protocol |
| TDD | Time Division |
| | Duplex |
| TDM | Time Division |
| | Multiplexing |
| TDMA | Time Division |
| | Multiple Access |
| TE | Terminal |
| | Equipment |
| TEID | Tunnel End |
| | Point Identifier |
| TFT | Traffic Flow |
| | Template |
| TMSI | Temporary |
| | Mobile |
| | Subscriber |
| | Identity |
| TNL | Transport |
| | Network Layer |
| TPC | Transmit Power |
| | Control |
| TPMI | Transmitted |
| | Precoding Matrix |
| | Indicator |
| TR | Technical |
| | Report |
| TRP, TRxP | Transmission |
| | Reception Point |
| TRS | Tracking |
| | Reference Signal |
| TRx | Transceiver |
| TS | Technical |
| | Specifications, |
| | Technical |
| | Standard |
| TTI | Transmission |
| | Time Interval |
| Tx | Transmission, |
| | Transmitting, |
| | Transmitter |
| U-RNTI | UTRAN |
| | Radio Network |
| | Temporary |
| | Identity |
| UART | Universal |
| | Asynchronous |
| | Receiver and |
| | Transmitter |
| UCI | Uplink Control |
| | Information |
| UE | User Equipment |
| UDM | Unified Data |
| | Management |
| UDP | User Datagram |
| | Protocol |
| UDSF | Unstructured |
| | Data Storage Network |
| | Function |
| UICC | Universal |
| | Integrated Circuit |
| | Card |
| UL | Uplink |
| UM | Unacknowledged |
| | Mode |
| UML | Unified |
| | Modelling Language |
| UMTS | Universal |
| | Mobile |
| | Telecommunications |
| | System |
| UP | User Plane |
| UPF | User Plane |
| | Function |
| URI | Uniform |
| | Resource Identifier |
| URL | Uniform |
| | Resource Locator |
| URLLC | Ultra- |
| | Reliable and Low |
| | Latency |
| USB | Universal Serial |
| | Bus |
| USIM | Universal |
| | Subscriber Identity |
| | Module |
| USS | UE-specific |
| | search space |
| UTRA | UMTS |
| | Terrestrial Radio |
| | Access |
| UTRAN | Universal |
| | Terrestrial Radio |
| | Access |
| | Network |
| UwPTS | Uplink |
| | Pilot Time Slot |
| V2I | Vehicle-to- |
| | Infrastruction |
| V2P | Vehicle-to- |
| | Pedestrian |
| V2V | Vehicle-to- |
| | Vehicle |
| V2X | Vehicle-to- |
| | everything |
| VIM | Virtualized |
| | Infrastructure Manager |
| VL | Virtual Link, |
| VLAN | Virtual LAN, |
| | Virtual Local Area |
| | Network |
| VM | Virtual |
| | Machine |
| VNF | Virtualized |
| | Network Function |
| VNFFG | VNF |
| | Forwarding Graph |
| VNFFGD | VNF |
| | Forwarding Graph |
| | Descriptor |
| VNFM | VNF Manager |
| VOIP | Voice-over-IP, |
| | Voice-over- |
| | Internet |
| | Protocol |
| VPLMN | Visited |
| | Public Land Mobile |
| | Network |
| VPN | Virtual Private |
| | Network |
| VRB | Virtual |
| | Resource Block |
| WiMAX | Worldwide |
| | Interoperability |
| | for Microwave |
| | Access |
| WLAN | Wireless Local |
| | Area Network |
| WMAN | Wireless |
| | Metropolitan Area |
| | Network |
| WPAN | Wireless |
| | Personal Area Network |
| X2-C | X2-Control |
| | plane |
| X2-U | X2-User plane |
| XML | extensible |
| | Markup |
| | Language |
| XRES | Expected user |
| | RESponse |
| XOR | exclusive OR |
| ZC | Zadoff-Chu |
| ZP | Zero Power |

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry.” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry.” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance.” “computer appliance.” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource. 25

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

1.-24. (canceled)

25. One or more non-transitory computer-readable media (NTCRM) having instructions, stored thereon, that when executed by one or more processors configure a next generation Node B (gNB) to:
encode, for transmission to a user equipment (UE), configuration information for transmission of a phase tracking reference signal (PTRS) with a plurality of PTRS ports, wherein the PTRS ports correspond to respective antenna panels of the UE that are capable of simultaneous uplink transmission; and
receive the PTRS from the UE according to the configuration information.

26. The one or more NTCRM of claim 25, wherein the instructions, when executed, further configure the gNB to encode, for transmission to the UE, sounding reference signal (SRS) configuration information for codebook-based or non-codebook-based uplink transmission, wherein the SRS configuration information includes multiple SRS resource sets that correspond to respective antenna panels of the UE or a single SRS resource set that corresponds to two or more of the antenna panels.

27. The one or more NTCRM of claim 25, wherein the instructions, when executed, further configure the gNB to encode a downlink control information (DCI) for transmission to the UE to schedule a physical uplink shared channel (PUSCH), wherein the DCI indicates sounding reference signal (SRS) resource indicators (SRIs) that correspond to respective antenna panels of the UE, and wherein the DCI further indicates one or multiple transmission precoding matrix indicators (TPMI) for the PUSCH.

28. The one or more NTCRM of claim 25, wherein each of the PTRS ports is associated with a subset of physical uplink shared channel (PUSCH) ports.

29. The one or more NTCRM of claim 25, wherein the instructions, when executed, further configure the gNB to encode a downlink control information (DCI) for transmission to the UE to schedule the uplink transmission, wherein the DCI indicates PTRS-demodulation reference signal (DMRS) associations for the respective PTRS ports.

30. The one or more NTCRM of claim 29, wherein the DCI includes a PTRS-DMRS field with 3 or 4 bits to indicate the PTRS-DMRS associations, or separate PTRS-DMRS fields to indicate the respective PTRS-DMRS associations.

31. The one or more NTCRM of claim 25, wherein the instructions, when executed, further configure the gNB to determine a parameter k_{ref}^{RE} that indicates a reference resource element position based on a respective demodulation reference signal (DMRS) antenna port of eight DMRS ports and a respective offset value of four offset values, wherein the PTRS is mapped to a frequency resource based on the parameter k_{ref}^{RE}.

32. One or more non-transitory computer-readable media (NTCRM) having instructions, stored thereon, that when executed by one or more processors configure a user equipment (UE) to:
decode configuration information for transmission of a phase tracking reference signal (PTRS) with a plurality of PTRS ports, wherein the PTRS ports correspond to respective antenna panels of the UE that are capable of simultaneous uplink transmission; and
encode the PTRS for transmission according to the configuration information.

33. The one or more NTCRM of claim 32, wherein the instructions, when executed, further configure the UE to decode sounding reference signal (SRS) configuration information for codebook-based or non-codebook-based uplink transmission, wherein the SRS configuration information includes multiple SRS resource sets that correspond to respective antenna panels of the UE or a single SRS resource set that corresponds to two or more of the antenna panels.

34. The one or more NTCRM of claim 32, wherein the instructions, when executed, further configure the UE to decode a downlink control information (DCI) to schedule a physical uplink shared channel (PUSCH), wherein the DCI indicates sounding reference signal (SRS) resource indicators (SRIs) that correspond to respective antenna panels of the UE.

35. The one or more NTCRM of claim 34, wherein the DCI further indicates one or multiple transmission precoding matrix indicators (TPMI) for the PUSCH.

36. The one or more NTCRM of claim 32, wherein each of the PTRS ports is associated with a subset of physical uplink shared channel (PUSCH) ports.

37. The one or more NTCRM of claim 32, wherein the instructions, when executed, further configure the UE to decode a downlink control information (DCI) for transmission to the UE to schedule the uplink transmission, wherein the DCI indicates PTRS-demodulation reference signal (DMRS) associations for the respective PTRS ports.

38. The one or more NTCRM of claim 37, wherein the DCI includes a PTRS-DMRS field with 3 or 4 bits to indicate the PTRS-DMRS associations, or separate PTRS-DMRS fields to indicate the respective PTRS-DMRS associations.

39. The one or more NTCRM of claim 32, wherein the instructions, when executed, further configure the UE to determine a parameter k_{ref}^{RE} that indicates a reference resource element position based on a respective demodulation reference signal (DMRS) antenna port of eight DMRS ports and a respective offset value of four offset values, wherein the PTRS is mapped to a frequency resource based on the parameter k_{ref}^{RE}.

40. One or more non-transitory computer-readable media (NTCRM) having instructions, stored thereon, that when executed by one or more processors configure a user equipment (UE) to:
receive configuration information for transmission of a sounding reference signal (SRS) with partial sounding and starting resource block (RB) hopping; and
encode the SRS for transmission based on the configuration information.

41. The one or more NTCRM of claim 40, wherein the starting RB hopping is performed within one frequency hopping period of the SRS or with a repetition factor greater than one.

42. The one or more NTCRM of claim 40, wherein the SRS has a number of symbols N_{Symbol}∈{1, 2, 4, 8, 10, 12, 14} and a repetition factor of R, wherein the starting RB hopping is applied with a number of hops N_{Hop} given by N_{Hop}=N_{symbol}/R, wherein individual hops include R symbols.

43. The one or more NTCRM of claim 40, wherein over different symbols within individual hops, the SRS is transmitted over a same set of sub-carriers, and wherein, for different hops, the SRS is transmitted over different sets of sub-carriers.

44. The one or more NTCRM of claim 40, wherein the SRS is a periodic SRS, a semi-persistent SRS, or an aperiodic SRS.
